(19) United States
(12) Patent Application Publication
(10) Pub. No.: US 2010/0281406 A1
(43) Pub. Date: Nov. 4, 2010

(54) INFORMATION PROVIDING DEVICE, INFORMATION DISPLAY DEVICE, INFORMATION PROVIDING SYSTEM, INFORMATION PROVIDING METHOD, PROGRAM, AND COMPUTER-READABLE STORAGE MEDIUM HAVING PROGRAM STORED THEREIN

(76) Inventors: Kazuyuki Yokogawa, Osaka (JP); Takanobu Matsubara, Osaka (JP); Kiyotaka Kashito, Osaka (JP)

Correspondence Address: BIRCH STEWART KOLASCH & BIRCH, PO BOX 747, FALLS CHURCH, VA, 22040-0747, US

(21) Appl. No.: 12/810,480

(22) PCT Filed: Dec. 12, 2008
(86) PCT No.: PCT/JP2008/073911

§ 371 Date: Jun. 24, 2010

Related U.S. Application Data
(60) Provisional application No. 61/009,220, filed on Dec. 27, 2007.

(30) Foreign Application Priority Data
May 16, 2008 (JP) 2008-130036

(51) Int. Cl. G06F 3/048

(52) U.S. Cl. 715/764

(57) ABSTRACT

A sidebar providing server (2) of the present invention includes: a service data cache processing section (66) that stores service setting data transmitted from a digital television (1) in a service setting data storage section (95); a request message analysis section (70) that receives display information indicating, for each service, whether or not to display an object showing a brief description of the service on the digital television (1); a service setting data updating section (68) that updates, at the time when the display information is received, service setting data, so that (i) the object indicated to be displayed is displayed and (ii) the object indicated not to be displayed is not displayed; and a display data generation section (63) that transmits, to the digital television (1), the display data (7) generated based on the service setting data in response to a request from the digital television (1).

### TECHNICAL FIELD

The present invention relates to an information providing device, an information display device, an information providing system, an information providing method, a program, and a computer-readable storage medium having such program stored therein, each of which is for providing information to a user of the information display device via a communication network.

### BACKGROUND ART

In recent years, not only general-purpose devices such as personal computers but also application-specific devices such as televisions, mobile phones and game machines include, as a standard fixture, a communication function for communicating with external devices via an external communication network such as the Internet. Each of these devices is capable of receiving various services from service distributing servers that provide various services, via the Internet.

Patent Document 1 discloses a technique that allows displaying, on an image display device that serves as a client, a photograph stored in a server device that is located in a remote area, by use of a network such as the Internet. The image display device requests a photograph from the server device via the network, in response to an operation of a user, and displays the photograph that is acquired, in response to the request, from the server device.

### [Patent Document 1]

Japanese Application No. 168098/2007 (Tokugan 2007-168098, filed on Jun. 26, 2007)

### DISCLOSURE OF INVENTION

### Problem to be Solved by the Invention

In the technique disclosed in Patent Document 1, regarding display (display order and whether or not to display preferentially) of a photograph album, update is carried out by an application (hereinafter, referred to as a dedicated application) capable of making an access to a record table of the photograph album which record table is stored in a storage section of the image display device.

It is preferable that a user can customize contents of the record table by using an application such as an web browser so that a service suitable for the user can be provided.

However, there is a problem in realizing a system in which the contents of the record table can be customized by using the dedicated application and the web browser. The problem is such that the contents of the record table cannot be exchanged between the dedicate application and the web browser.

The present invention is attained in view of the problem explained above. An object of the present invention is to provide an information providing device, an information display device, an information providing system, an information providing method, a program, and a computer-readable storage medium having such program stored therein, each of which is for allowing data stored in a terminal to be shared between different applications in the terminal by processing the data in a service device.

### Means to Solve the Problem

In order to solve the above problem, an information providing device of the present invention includes: service setting data storage section that stores, in a first storage section, service setting data in which service identification information of at least one service provided to an information display device corresponds to display attribute information indicating whether or not to display an object showing a brief description of the service identified by the service identification information, the service setting data being transmitted from the information display device; display information reception section that receives, from the information display device, display information indicating, for each of the at least one service, whether or not to display the object on the information display device; service setting data update section that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section; display data generation section that, in response to a request from the information display device, generates: display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and display data transmission section that transmits, to the information display device, the display data generated.

Further, an information providing method includes the steps of: storing, in a first storage section, service setting data in which service identification information of at least one service provided to an information display device corresponds to display attribute information indicating whether or not to display an object showing a brief description of the service identified by the service identification information, the service setting data being transmitted from the information display device; receiving, from the information display device, display information indicating, for each of the at least one service, whether or not to display the object on the information display device; updating, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section; in response to a request from the information display device, generating: display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and transmitting, to the information display device, the display data generated.

According to the arrangement, the service setting data transmitted from the information display device can be stored in the first storage section. Moreover, the display information can be received from the information display device. Further, when the display information is received, the service setting data stored in the first storage section can be updated so that updated service setting data indicates to display the object indicated to be displayed and indicates not to display the object indicated not to be displayed. Furthermore, in response to a request from the information display device, it is possible to generate display data including (i) the object of the service identified by the service identification information and (ii) a control script for displaying the object on the information display device in a case where the service setting data stored in the first storage section has been updated, which object and control script are associated with the display attribute information that is included in the updated service setting data and indicates to display the object on the information display device. It is also possible to generate display data including (i) the object of the service identified by the service identification information and (ii) the control script of the object in a case where the service setting data stored in the first storage section has not been updated, which object and control script are associated with the display attribute information that is included in the service setting data included in the request and indicates to display the object on the information display device. In addition, thus generated display data can be transmitted to the information display device.

The above arrangement allows updating, according to the display information received from the information display device, the service identification information included in the service setting data that is received from the information display device and stored in the first storage section. The arrangement also makes it possible to generate the display data according to the updated service setting data in response to the request from the information display device.

Accordingly, it becomes possible to transmit, to the information display device, the display data on which whether or not to display the object on the information display device is reflected.

An information providing system of the present invention includes the information providing device and the information display device.

According to the arrangement, the information providing device can store, in the first storage section, at least the service setting data transmitted from the information display device. Moreover, the display information can be received from the information display device. Further, when the display information is received, the service setting data stored in the first storage section can be updated so that (i) the object that is indicated to be displayed is displayed and (ii) the object that is not to be displayed is not displayed. Moreover, in response to the request from the information display device, the display data can be transmitted to the information display device. Furthermore, in a case where the service setting data stored in the first storage section has been updated, the display data can be generated based on the updated service setting data. In a case where the service setting data stored in the first storage section has not been updated, the display data can be generated based on the service setting data included in the request.

The information display device can request the information providing device to store, in the information providing device, the service setting data stored in the second storage section of the information display device. Moreover, for updating the service setting data stored in the information providing device, the display information can be transmitted to the information providing device. Further, the information display device can make a request for the display data generated based on the updated service setting data, to the information providing device. The information display device can display, on a display section of the information display device, the object included in the acquired display data, according to the control script that is included in the display data acquired from the information providing device in response to the request.

Therefore, the information providing device can store the service setting data received from the information display device and update the stored service setting data based on the display information received from the information display device. In addition, the information display device can acquire the display data generated based on the service setting data and display the object on the information display device.

Accordingly, based on the service setting data updated in the information providing device, the information display device can display the object on the information display device.

Further, update of the service setting data becomes possible in the first storage section, even in a case where, for example, a function (e.g., web browser) of the information display device which function updates the service setting data and a function (e.g., dedicated application) of the information display device which function makes a reference to the service setting data cannot directly exchange the service setting data. Moreover, it becomes possible to share the service setting data between the functions, by making it possible to acquire, from the first storage section, the display data generated based on the updated service setting data.

Note that the information providing device and the information display device may be realized by a computer. In such a case, the present invention encompasses a control program of the information providing device and the information display device which program is for realizing the information providing device and the information display device by a computer by causing the computer to function as the sections of the information providing device and the information display device, and a computer-readable storage medium having the control program stored therein.

### BRIEF DESCRIPTION OF DRAWINGS

FIG. 1 is a drawing showing a schematic configuration of a service providing system of an embodiment of the present invention.

FIG. 2 is a drawing showing an example of a schematic configuration of a digital television in the service providing system explained in FIG. 1.

FIG. 3 is a drawing schematically showing a data structure of a display data request message generated by the digital television explained in FIG. 2.

FIG. 4 is a block diagram showing a schematic configuration of a sidebar providing server in the service providing system explained in FIG. 1.

FIG. 5 is a drawing schematically showing a data structure of display data generated by the sidebar providing server explained in FIG. 4.

FIG. 6 is a schematic drawing showing a data format of service setting data handled by the service providing system explained in FIG. 1.

FIG. 7 is a schematic drawing showing an example of the service setting data explained in FIG. 6.

FIG. 8 is a schematic drawing showing another example of the service setting data explained in FIG. 6.

FIG. 9 is a flow chart showing an example of a series of processing steps for display setting of a service to be included in the sidebar in the service providing system explained in FIG. 1.

FIG. 10 is a flow chart showing an example of a flow of display data generation processing in the flow shown in FIG. 9.

FIG. 11 is a flow chart showing an example of a flow of service setting data cache processing in the flow shown in FIG. 9.

FIG. 12 is a flow chart showing an example of a flow of service display setting screen generation processing in the flow shown in FIG. 9.

FIG. 13 is a flow chart showing an example of a flow of service display setting reflection processing in the flow shown in FIG. 9.

FIG. 14 is a drawing showing an example of a screen in a state where the digital television explained in FIG. 2 has not acquired display data.

FIG. 15 is a drawing showing an example of a screen in a state where the digital television explained in FIG. 2 displays a sidebar.

FIG. 16 is a drawing showing an example of a screen showing a state where the digital television explained in FIG. 2 displays a service that is downloaded from a service distributing server 3.

FIG. 17 is a drawing showing an example of a screen in a state where the digital television shown in FIG. 2 displays an object for calling a service display setting screen.

FIG. 18 is an example of a screen in a state where the digital television explained in FIG. 2 displays a service display setting screen.

FIG. 19 is a drawing showing an example of a screen in a state that occurs after an “ADD” button in a column of a stock quotation service is pressed down in the example of the screen shown in FIG. 18.

FIG. 20 is a drawing showing an example of a screen of the digital television explained in FIG. 2 at the time when a service display setting result is reflected on service setting data kept by a sidebar providing server.

FIG. 21 is a drawing illustrating an example of a screen in a state where the digital television explained in FIG. 2 acquires display data again after the state of the example of the screen shown in FIG. 20.

FIG. 22 is a flow chart showing a series of processing steps for setting information necessary for providing a service included in a sidebar in the service providing system explained in FIG. 1.

FIG. 23 is a flow chart showing an example of a flow of service setting reflection processing in the flow shown in FIG. 22.

FIG. 24 is a drawing showing an example of a screen in a state where the digital television explained in FIG. 2 displays a service setting screen 11.

FIG. 25 is a drawing showing an example of a screen in a state where the digital television explained in FIG. 2 acquires display data, after service setting is carried out, and displays a sidebar.

### REFERENCE NUMERALS

1 digital television (information display device)
2 sidebar providing server (information providing device)
3 service distributing server (service providing device)
4 service-setting-data-storage request message
5 display data request message
6 image (object)
7 display data
7′ sidebar
8 service
9 service display setting screen (first user interface)
10 control section
11 service setting screen (second user interface)
14 image superimposing section
16 display section
17 storage section (second storage section)
20 temporary storage section
21 interface section
30 event processing section
32 display data request processing section (display data request means)
33 display data execution processing section (display data reception means, service setting data reception means)
34 browser processing section (display information transmission means, setting information transmission means)
35 service-display-setting-screen acquisition processing section (service-setting-data-storage request means)
60 control section
62 pattern data selecting section
63 display data generation section (display data generation means, display data transmission means, service setting data transmission means)
64 service image acquisition section
66 service-setting-data cache processing section (service setting data storage section)
67 service-display-setting-screen generation section (display setting interface providing means)
68 service setting data updating section (service setting data update means)
69 service setting reflection processing section (setting information update means)
70 request message analysis section (display information reception means)
80 control script generation section
90 storage section
91 pattern data storage section
92 service image storage section
93 common object storage section
94 control data storage section
95 service setting data storage section (first storage section)
100 service providing system (information providing system)

### BEST MODE FOR CARRYING OUT THE INVENTION

One embodiment of the present invention is described below with reference to the attached drawings. The present embodiment discusses an example in which an information display device of the present invention is a digital television. Further, an information providing device of the present invention is explained as a sidebar providing server for providing a sidebar function to digital televisions. The sidebar function is a tool for (i) displaying brief description information of services that are available on the digital television and (ii) activating such services. The sidebar function is described later in detail.

When a service is activated via a sidebar displayed on a digital television, contents of the service is provided to the digital television from a service distributing server of a service provider.

In the following explanation, an information providing system of the present invention is applied to a service providing system including the digital television, the sidebar providing server and the service distributing server.

However, the information display device, the information providing device and the information providing system of the present invention are not limited to the following concrete examples.

(Outline of Service Providing System)

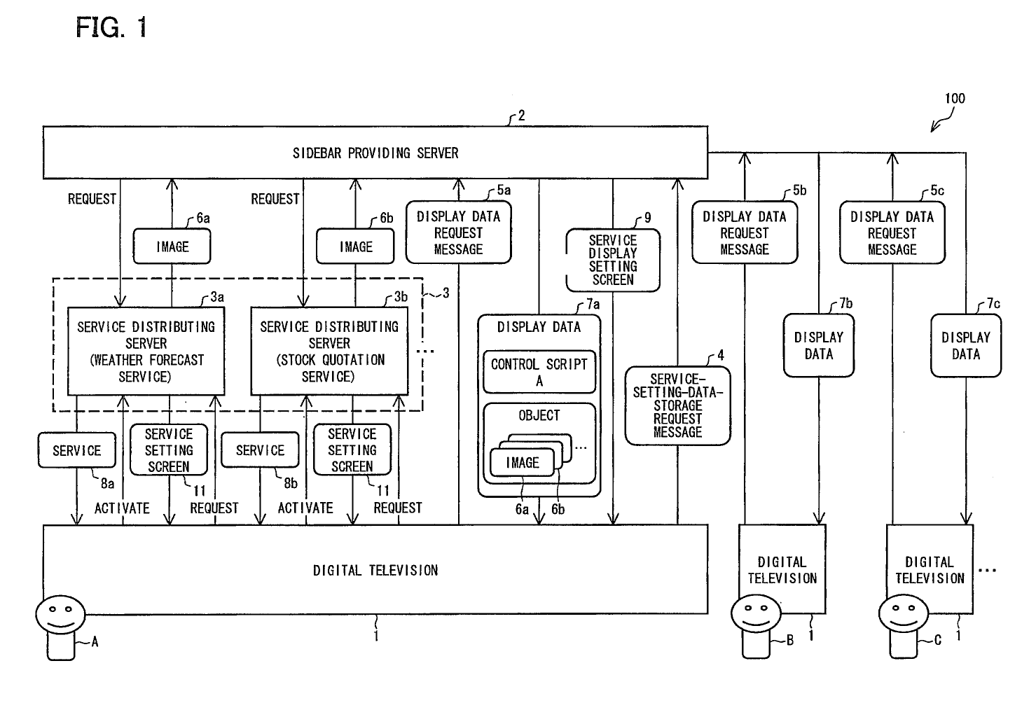

With reference to FIG. 1, a service providing system 100 of an embodiment of the present invention is briefly explained. FIG. 1 is a drawing showing a schematic configuration of the service providing system 100 of the embodiment of the present invention. As shown in FIG. 1, the service providing system 100 includes a digital television 1, a sidebar providing server 2 and a service distributing server 3.

The digital television 1 carries out a sidebar function provided from the sidebar providing server 2 and uses services provided by the service distributing server 3.

The sidebar function is a function of a digital television, and the function includes a sidebar displaying function and a service launcher function. The sidebar displaying function is a function of displaying, on a corner of a screen of the digital television, brief descriptions of services which are available in the digital television, like a toolbar (OSD (On-Screen-Display)). The service launcher function is a function of activating a service displayed on the sidebar when the service is selected.

One or more than one digital television 1 requests the sidebar providing server 2 to provide display data 7 (7a, 7b, 7c . . . ) necessary for displaying, on the digital television 1, a sidebar having the above function. Specifically, the digital television 1 transmits a display data request message 5 (5a, 5b, 5c . . . ) to the sidebar providing server 2. The display data 7 and the display data request message 5 are later described in detail.

The sidebar providing server 2 provides the display data 7 generated specially for the digital television 1 independently, to the digital television 1 in response to the display data request message 5 transmitted from the digital television 1. The sidebar providing server 2 tailor-makes the display data 7 specially for each digital television 1 independently.

First, the sidebar providing server 2 requests the service distributing server 3 (3a, 3b . . . ), that distributes services, to provide an image 6 (6a, 6b . . . ) showing a brief description of a service to be contained in the sidebar. The sidebar providing server 2 requests the image from one or more than one service distributing server 3. How many service providing servers 3 and which service distributing server 3 the sidebar providing server 2 requests the image from differs according to the digital television 1 requesting the sidebar. That is, the sidebar providing server 2 customizes the display data 7 (contents of the sidebar) according to the digital television 1 requesting the sidebar.

The service distributing server 3 may provide the image 6 in response to the request of the sidebar providing server 2. As an alternative, when information is updated in the service distributing server 3, the service distributing server 3 may provide, to the sidebar providing server 2, the image 6 containing the updated information.

Further, in the example shown in FIG. 1, the service distributing server 3 provides, to the sidebar providing server 2, the information containing a brief description of a service by using image-form data such as the image 6. However, a form of the data is not limited to this. For example, the service distributing server 3 may provide, in response to the request of the sidebar providing server 2, text-form data, or complex data containing image data and text data, as brief description information of a service.

The sidebar providing server 2 generates the display data 7 containing collected objects such as the image 6 and a control script for determining how the objects are displayed, and then transmits the display data 7 to the digital television 1. The digital television 1 can display a sidebar customized for the digital television 1 by analyzing and executing the display data 7. Brief description information of various services which can be used in the digital television 1 is displayed on the sidebar, and when a service is selected by a user (A, B, C . . . ), that service selected is activated.

The service distributing server 3 returns, in response to the request of the sidebar providing server 2, the image 6 showing a brief description of a service, and at the same time, provides a service 8 (8a, 8b . . . ) in response to the request of the digital television 1 via the sidebar. For example, when the service distributing server 3 provides a weather forecast service to a user, the service distributing server 3 provides the service 8a containing weather forecast information. The service distributing server 3 may be plural. Further, the service 8 may be provided to a plurality of digital televisions 1.

As described above, according to the service providing system 100, the digital television 1 can acquire, from the sidebar providing server 2, the sidebar function customized for the digital television 1 and can display the sidebar on the digital television 1. A user of the digital television 1 can easily activate desired services by using the customized sidebar.

Further, the digital television 1 requests a service display setting screen 9 (for example, HTML data) explained later from the sidebar providing server 2, so that it is allowed to set a service to be displayed and a service not to be displayed on the sidebar. Specifically, the digital television 1 requests the service display setting screen 9 by sending a service-setting-data-storage request message 4 explained later to the sidebar providing server 2.

In addition, the digital television 1 requests the service distributing server 3 to provide a service setting screen 11 (for example HTML data) explained later, so as to make it possible to set information necessary for customizing and providing a service.

(Digital Television)

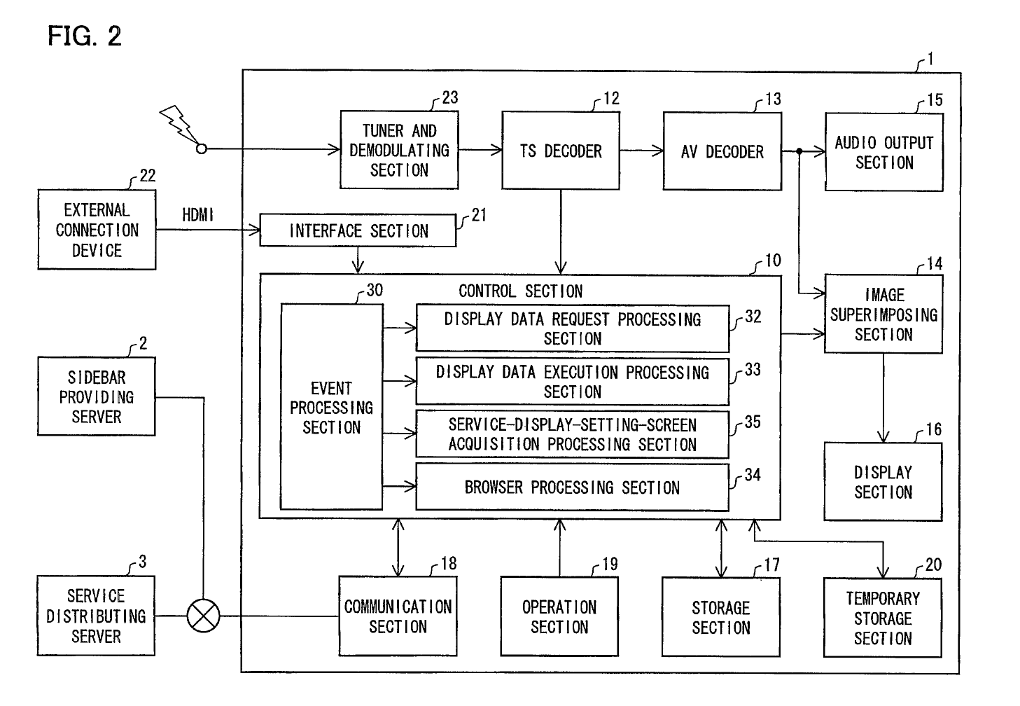

FIG. 2 is a drawing showing an example of a schematic configuration of the digital television 1 of an embodiment of the present invention. Some constituents as shown in FIG. 2 solely serve to explain general functions of a digital television and do not limit an arrangement of an information display device of the present invention.

As shown in FIG. 2, the digital television 1 includes a control section 10, a tuner and demodulating section 23, a TS (transport stream) decoder 12, an AV (audio visual) decoder 13, an image superimposing section 14, an audio output section 15, a display section 16, a communication section 18, an operation section 19, a storage section 17, a temporary storage section 20, and an interface section 21.

The control section 10 controls various kinds of operations of each section of the digital television 1. Further, the control section 10 includes, as functional blocks, an event processing section 30, a display data request processing section 32, a display data execution processing section 33 and a browser processing section 34, a service-display-setting-screen acquisition processing section 35. With this arrangement, it is possible to request the display data 7 necessary for displaying a sidebar, to display an acquired sidebar, to activate services, to display acquired services, and to set a service to be displayed in the sidebar.

The tuner and demodulating section 23 for digital broadcasting carries out tuning to select a digital broadcast signal supplied via an antenna from a broadcast station (not shown), performs demodulation and error correction of the received signal in accordance with a form of the signal, and forms multiplexed digital data. The tuner and demodulating section 23 outputs the multiplexed digital data to the TS decoder 12.

The TS decoder 12 extracts a TS (transport stream) by decoding the multiplexed digital data outputted by the tuner and demodulating section 23 and separate the TS into TS packets for different purposes. The TS packets are transmitted to the AV decoder 13 or the control section 10 in accordance with the purposes. Here, the TS is a signal sequence constituted by the TS packets of the fixed length. Each TS packet may contain data signals of program information and information necessary for channel selection, in addition to video and audio signals. The TS decoder 12 separates the extracted TS into (i) TS packets (broadcast data) that contain video and audio signals and are to be outputted to the AV decoder 13 and (ii) TS packets (information data) that contain signals of various information and are to be outputted to the control section 10.

The AV decoder 13 separates the video signal and the audio signal by decoding the TS packets (broadcast data) outputted from the TS decoder 12. The AV decoder 13 outputs the video signal to the image superimposing section 14 and the audio signal to the audio output section 15.

The image superimposing section 14 outputs, to the display section 16, screen data obtained by superimposing, on the video signal decoded by the AV decoder 13, OSD (On-Screen-Display) image data (e.g., sidebar) generated by the digital television 1. This makes it possible to display a screen on which the video signal of the broadcast data and the OSD image data such as a sidebar, a channel call, a menu panel and an electronic program guide (EPG) are superimposed.

The audio output section 15 outputs audio based on the audio signal of the digital television 1. For example, the audio output signal is realized by a speaker.

The display section 16 is a display device for displaying a video and/or an image of the digital television 1. For example, the display section 16 is realized by a display device such as an LCD (liquid crystal display), a PDP (plasma display panel) or a CRT (cathode-ray tube) display.

The storage section 17 stores a control program executed by the control section 10, an OS program and various kinds of data (e.g., service setting data later explained) that is read by the control section 10 when the control section 10 carries out the display data request processing and the sidebar function. The storage section 17 is constituted by a nonvolatile storage device.

For example, a disc type storage medium such as a DVD (Digital Video Disc) and a hard disc, or a semiconductor memory such as a flash memory can be suitably used for the storage device constituting the storage section 17.

The temporary storage section 20 temporarily stores data utilized by the control section 10. The temporary storage section 20 is made of a volatile storage device. The data stored temporarily is, for example, a program read out from the storage section 17, various kinds of data, or the display data 7 acquired by the sidebar providing server 2.

The communication section 18 transmits/receives information to/from various communication devices, such as the sidebar providing server 2 and the service distributing server 3, via a communication network such as the Internet. The communication section 18 is capable of, for example, transmitting the display data request message 5 to the sidebar providing server 2 and receiving, from the sidebar providing server 2, the sidebar display data 7 customized for the digital television 1. The communication section 18 is also capable of receiving the service display setting screen 9 from the sidebar providing server 2 after transmitting, to the sidebar providing server 2, the service-setting-data-storage request message 4 explained later. Further, the communication section 18 is capable of communicating with the service distributing server 3 via the sidebar so as to receive, from the service distributing server 3, the service 8 of a target.

The operation section 19 is an input device via which a user inputs a signal for operating the digital television 1. The present embodiment discusses, as an example, the operation section 19 that includes, for example, a remote controller for a remote control operation outside the digital television 1.

The digital television 1 includes, in its main body, a light receiving section (not shown) that receives an instruction signal (e.g., an infrared signal) that is inputted by a key operation on the remote controller. The instruction signal received by the light receiving section is transmitted to an input/output control section (not shown) of the control section 10. The input/output control section of the control section 10 accepts and analyzes the instruction signal that is inputted from a user into the digital television 1 via the operation section 19. Then, the instruction signal is transmitted to various sections, in need of the instruction signal, in the control section 10.

The interface section 21 performs input/output of a video signal and a control signal through, for example, an HDMI cable that is connected to an external connection device 22. The interface section 21 includes, for example, an HDMI cable terminal and an HDMI signal processing section. Examples of the external connection device 22 are a reproducing device for BD (Blue ray Disk) and an HDD (Hard Disk) recorder. The digital television 1 transmits/receives a video signal and a control signal to/from the external connection device 22 via the interface 21, so as to display a video stored in the external connection device 22 or to store, in the external connection device 22, the video signal that the digital television 1 obtains.

The event processing section 30 of the control section 10 detects various events that occur in the digital television 1, and transmits a predetermined signal to various sections of the control section 10, for example, the display data request processing section 32 and the display data execution processing section 33. For example, the event processing section 30 detects a state such that a user presses a key of the operation section 19.

The display data request processing section 32 generates the display data request message 5 for requesting a sidebar from the sidebar providing server 2.

The display data execution processing section 33 analyzes the display data 7 that is provided from the sidebar providing server 2 and displays a sidebar. The display data execution processing section 33 also accepts a selection of a service from a user and activates the service of the service distributing server 3.

The service-display-setting-screen acquisition processing section 35 generates the service-setting-data-storage request message 4 that is to be transmitted to the sidebar providing server 2 and transmits the service-setting-data-storage request message 4 to the sidebar providing server 2. The service-display-setting-screen acquisition processing section 35 also requests data of the service display setting screen 9 from the sidebar providing server 2, according to a response (control data) in response to the service-setting-data-storage request message 4 from the sidebar providing server 2. A flow of this processing is explained later in detail.

The browser processing section 34 processes, for example, (i) HTML data (the service 8, the service display setting screen 9, and the service setting screen 11) acquired via the communication section 18 from the outside or (ii) HTML data stored in advance in the storage section 17, so that information included in the data is displayed.

When an instruction to acquire a service setting screen is inputted by a user through the service display setting screen 9 and the browser processing section 34 accepts the instruction, the browser processing section 34 requests the service setting screen from the service distributing server 3. When an instruction to check a service setting value (setting information) is inputted by a user through the service display setting screen 11 and the browser processing section 34 accepts the instruction, the browser processing section 34 requests the service distributing server 3 to check whether or not the service setting value is appropriate. Further, when an instruction to store the service setting value is inputted by a user through the service display setting screen 11 and the browser processing section 34 accepts the instruction, the browser processing section 34 requests the sidebar providing server 2 to store a result of service setting. A flow of this processing is explained later in detail.

(Display Data Request Message)

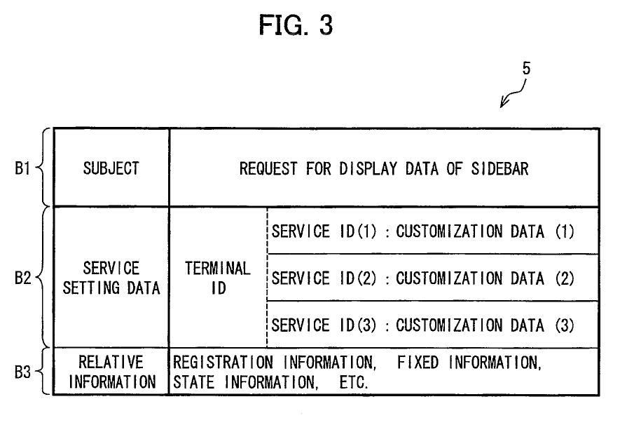

FIG. 3 is a drawing schematically illustrating a data structure of the display data request message 5 that is generated by the display data request processing section 32. In an example shown in FIG. 3, the display data request message 5 is formed as a structure including three blocks (B1 to B3) as a set. Each of the three blocks has a meaning.

A “subject” as a first block (B1) stores data indicating that the message is a message for requesting the display data 7 of the sidebar. In a case where there is no value stored in the “subject”, the sidebar providing server 2 may detect, as a default, that the message is a message for requesting the display data 7 of the sidebar.

“Service setting data” as a second block (B2) stores information (e.g., service ID) for specifying a service that a user of the digital television 1 desires to include in the sidebar. In the present embodiment, the service setting data is stored as binary data. The sidebar providing server 2 that receives the binary data takes the binary data as information that has a meaningful structure. More specifically, contents of the binary data are as follows. On the assumption that three brief descriptions of services are included in the sidebar, service IDs for the three are included in the binary data. Further, information (customization data) necessary for each of the service providing servers 3 providing the services may be stored so as to correspond to a corresponding service ID. Further, in the present embodiment, a terminal ID for identifying the digital television 1 is associated with the three service IDs that are stored in the block. The terminal ID may be anything as long as the terminal ID allows the sidebar providing server 2 to uniquely identify each of digital televisions 1 to which the sidebar providing server 2 provides a sidebar. For example, a MAC address or a production serial number may be directly used as the terminal ID. Alternatively, an ID that the sidebar providing server 2 independently produces may be assigned as the terminal ID. According to the service setting data, the sidebar providing server 2 can specify a service (the service distributing server 3 from which the sidebar providing server 2 is to request an image) to be included in the sidebar that is to be provided to the digital television 1.

“Relevant information” as a third block (B3) stores information concerning the digital television 1. This information is independently stored in the digital television 1. The display data request processing section 32 stores, in this block, various kinds of relevant information stored in the storage section 17 or the temporary storage section 20.

Consequently, the sidebar providing server 2 can generate the display data 7 that is customized according to the digital television 1, by using the service setting data. It is explained later in detail how the display data 7 customized according to the service setting data is generated in the sidebar providing server 2.

A data type of the data of each of the blocks is selected as appropriate according to contents, capacity, and usage that are indicated by the data.

The above explanation describes the display data request message 5 as a structure including, as a set, the three blocks. However, an arrangement of the display data request message 5 is not limited to this. For example, by connecting the above terminal ID to each corresponding block, the display data request processing section 32 may separately produce each information of the “subject”, the “service setting data”, and the “relative information” so as to transmit the information. In this case, for example, first, the “subject” that conveys a will to request the display data 7 is transmitted. Then, only the information (e.g., service setting data) necessary for the sidebar providing server 2 is generated and transmitted in response to the request from the sidebar providing server 2.

(Service-Setting-Data-Storage Request Message)

A data structure of the service-setting-data-storage request message 4 is the same as the data structure of the display data request message 5 illustrated in FIG. 3. However, the first block “subject” stores data indicating that the message is a massage for requesting storage of the service setting data. Then, the second block “service setting data” stores data including the service ID which the sidebar providing server 2 is desired to store.

Moreover, in the same manner as the display data request message 5, the customization data may be stored so as to correspond to the service ID. Further, in the same manner as the display data request message 5, the terminal ID for identifying the digital television 1 is stored so as to correspond to the service setting data that is stored in the block.

(Sidebar Providing Server)

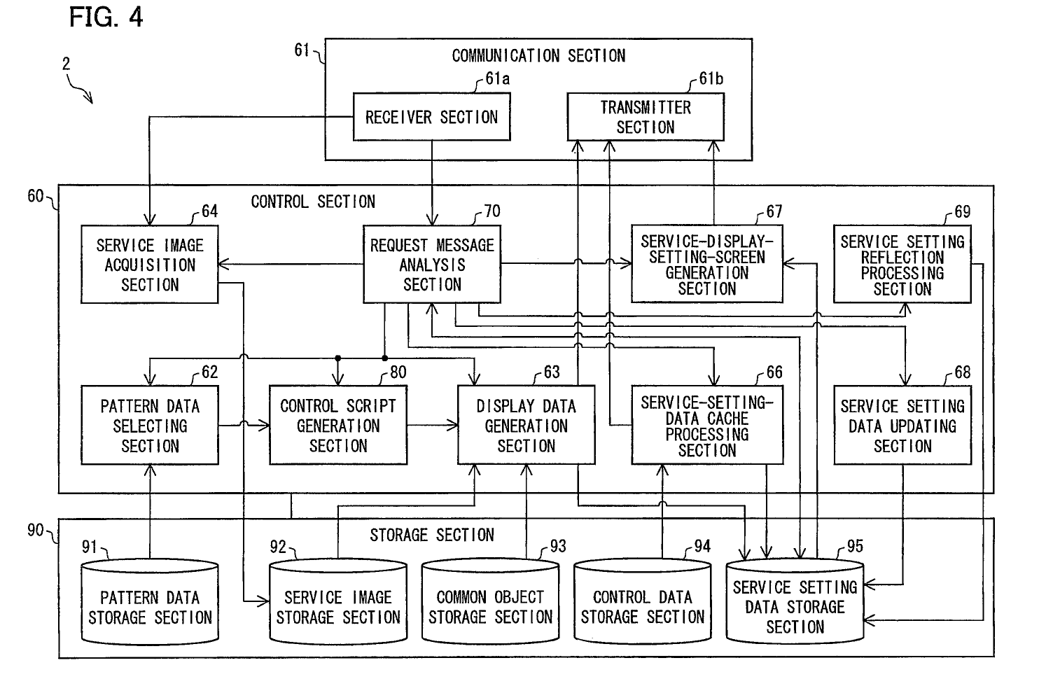

FIG. 4 is a block diagram schematically illustrating an arrangement of the sidebar providing server 2 in the embodiment of the present invention. The sidebar providing server 2, as shown in FIG. 4, includes a control section 60 that collectively controls sections of the sidebar providing server 2, a communication section 61, and a storage section 90.

The control section 60 controls various operations of the respective sections provided in the sidebar providing server 2. The control section 60 includes, as function blocks, a request message analysis section 70, a control script generation section 80, a pattern data selecting section 62, a display data generation section 63, a service image acquisition section 64, a service-setting-data cache processing section 66, a service-display-setting-screen generation section 67, a service setting data updating section 68, and a service setting reflection processing section 69. The control section 60 reads out various programs stored in the storage section 90 and controls sections of the sidebar providing server 2 of the present invention, so as to carry out various processings for generating the display data (and a control script included in the display data) and various processings for generating the service display setting screen (e.g., HTML data).

The storage section 90 stores a control program that the control section 60 executes, an OS program, and various data that the control section 60 reads out when executing the various processings. The storage section 90 is made of an involatile storage device such as a hard disk. The various data above is stored in various storage sections inside the storage section 90. In other words, the various data is stored in, for example, a pattern data storage section 91, a service image storage section 92, a common object storage section 93, a control data storage section 94, and a service setting data storage section 95. The various data stored in the storage section 90 is not limited to the data discussed above.

The communication section 61 communicates with each device of the service providing system 100 via a communication network. The communication section 61 includes a receiver section 61a and a transmitter section 61b.

Specifically, the receiver section 61a receives the display data request message 5 that is transmitted from the digital television 1. The display data request message 5 accepted via the receiver section 61a is transmitted to the request message analysis section 70 of the control section 60. Moreover, the receiver section 61a receives the image 6 that is transmitted from the service distributing server 3. The image 6 received by the receiver section 61a is transmitted to the service image acquisition section 64.

The transmitter section 61b makes a request to the service distributing server 3 for the image 6 indicative of a brief description of a service. The image 6 is necessary for producing the display data 7 requested. That is, the transmitter section 61b makes a request for the necessary image 6 to the service distributing server 3 that is designated by the service image acquisition section 64.

The transmitter section 61b transmits the display data 7 generated in response to the request from the digital television 1. That is, the transmitter section 61b transmits, to the digital television 1 that has made a request, the display data 7 transmitted from the display data generation section 63.

Further, the transmitter section 61b transmits, to the digital television 1, control data (data for making an access to a web page providing the service display setting screen 9) that the service-setting-data cache processing section 66 outputs in response to the service-setting-data-storage request message 4.

Furthermore, the transmitter section 61b transmits, to the digital television 1, data (e.g., HTML data) of the service display setting screen 9 that is generated by the service-display-setting-screen generation section 67 in response to the request of acquiring the service display setting screen 9.

The request message analysis section 70 analyzes the display data request message 5 transmitted from the digital television 1. For example, the request message analysis section 70 analyzes the display data request message 5 as shown in FIG. 3, and transmits an analysis result (e.g., subject, service setting data, relative information) to sections that operates for generating the display data 7. In a case where the service setting data storage section 95 stores updated service setting data of the digital television 1 that has transmitted the display data request message 5 (in a case where an update flag is given as explained later), the request message analysis section 70 transmits, to the sections that operate for generating the display data 7, the stored updated service setting data in place of the service setting data that is included in the analysis result of the display data request message 5.

Moreover, the request message analysis section 70 analyzes the service-setting-data-storage request message 4 that is transmitted from the digital television 1. Then, the request message analysis section 70 transmits an analysis result (e.g., subject, service setting data, and relative information) to the service-setting-data cache processing section 66 that operates for performing processing of storing the service setting data and processing of transmitting the control data.

Further, the request message analysis section 70 analyzes a request for acquiring the service display setting screen 9. This request is sent from the digital television 1. Then, the request message analysis section 70 transmits an analysis result to the service-display-setting-screen generation section 67 that operates for generating the service display setting screen 9.

Furthermore, the request message analysis section 70 analyzes a service display setting result (data that repeats a set of a service ID and information indicating whether or not to display a service (e.g., “1” indicating to display and “0” indicating not to display))(display information (information on whether or not to display a service)) that is transmitted from the digital television 1. Then, the request message analysis section 70 transmits an analysis result to the service setting data updating section 68 that operates for updating the service setting data.

In addition, the request message analysis section 70 analyzes service setting data (explained later) that is transmitted from the digital television 1. Then, the request message analysis section 70 transmits an analysis result to the service setting reflection processing section 69 that operates for updating the service setting data.

The service image acquisition section 64 acquires an object required for generating the requested display data 7, in accordance with the analysis result of the request message analysis section 70. More specifically, the service image acquisition section 64 (i) specifies a service distributing server 3 to be requested to provide an image 6 illustrating a brief description of a required service, based on the service ID shown in the service setting data and (ii) requests the service distributing server 3 to provide such an image 6. The storage section 90 stores information regarding the service distributing server 3 to be requested to provide the image 6 in a manner such that the information corresponds to the service ID (service information storage section, not illustrated).

It may be arranged such that the image 6 acquired from the service distributing server 3 is stored for a predetermined period in the service image storage section 92 so that the service image acquisition section 64 acquires a desired image 6 from the service image storage section 92.

The service image acquisition section 64 may acquire an image 6 appropriate for the digital television 1 based on customization data contained in the service setting data. For example, the following explanation uses a weather forecast service as an example. It is desirable for the service image acquisition section 64 to acquire an image 6 that illustrates a brief description of a weather forecast of a region of the user that uses the digital television 1. At this time, in a case where postal code information (ZIP code) is contained in the service setting data as customization data of the weather forecast, the image 6 illustrating the brief description of the weather forecast of the region indicated by the postal code information is to be acquired from the service distributing server 3 or the service image storage section 92.

When the requested image 6 is received from the service distributing server 3, the service image acquisition section 64 stores the image 6 in the service image storage section 92.

The service image acquisition section 64 may request and acquire, not limited to the image 6, text-form data or complex data containing text-form and image-form data as information related to the brief description of the service.

The pattern data selecting section 62 selects pattern data for generating the requested display data 7 in accordance with an analysis result of the request message analysis section 70. The pattern data selecting section 62 selects, from the pattern data storage section 91, pattern data specified by the analysis result. The pattern data selected by the pattern data selecting section 62 is transmitted to the control script generation section 80 and the display data generation section 63.

The pattern data is data in which descriptions are made for a part (fixed part) that is common in content regardless of the digital television 1 (fixed part), in the control script which configures the display data 7 of the sidebar. Namely, the pattern data is a template of the display data 7. In the pattern data, a part other than the fixed part, that is, a part which is customized in accordance with relevant information of the digital television 1, has scripts in a state such that contents can be later embedded.

The control script generation section 80 generates a control script to be contained in the requested display data 7 by use of the pattern data selected by the pattern data selecting section 62.

The control script generation section 80 completes, in the entire control script, the control script of the part which require customizing by embedding the contents, by use of the analysis result of the request message analysis section 70 and the pattern data selected by the pattern data selecting section 62. For example, a script specifying an object (image 6) acquired from the service distributing server 3, or a script specifying a location (URL) of data that is to be accessed when the object is selected by a remote controller, is embedded in the part which require the customization.

The control script generation section 80 that completes the control script by embedding contents from the pattern data can be realized based on known techniques disclosed in Japanese Unexamined Patent Publication, Tokukai, No. 2006-24137, for example.

The display data generation section 63 generates display data 7 specified by the display data request message 5, and transmits this display data 7 to the digital television 1. More specifically, the display data generation section 63 generates the display data 7 for displaying the sidebar requested by the digital television 1, by combining (for example, compiling to one file in zip form) (i) the control script generated by the control script generation section 80 and (ii) an object included in the control script, which object is specified by a script that specifies the object. The object may be: an image of a button commonly used in all sidebars; the image 6 acquired from the service distributing server 3; or the like. Images used in common are stored in the common object storage section 93. The image 6 acquired from the service distributing server 3 is stored in the service image storage section 92. The display data generation section 63 may select a common image suitable for the digital television 1 among a plurality of the common images, in accordance with the contents of the display data request message 5.

The display data 7 generated as such includes the request from the digital television 1, that is, an optimum control script and object in accordance with the contents (service setting data) of the display data request message 5.

The service-setting-data cache processing section 66 extracts service setting data included in the service-setting-data-storage request message 4. The service-setting-data cache processing section 66 further extracts a terminal ID from thus extracted service setting data. Then, the service-setting-data cache processing section 62 stores the extracted terminal ID and the extracted service setting data into the service setting data storage section 95 in a manner such that the terminal ID and the service setting data corresponds to each other.

Then, the service-setting-data cache processing section 66 generates control data as output data. The control data is data used for making an access to a web page that provides the service display setting screen 9. The control data is a set of (i) a layout definition script that describes to jump to the web page according to a URL including the extracted terminal ID and (ii) an operation content definition script that describes to execute the layout definition script. The service-setting-data cache processing section 66 reads templates of the layout definition script and the operation content definition script that are stored in advance in the data storage section 94 and embeds necessary data (the extracted terminal ID or data that allows specifying the terminal ID), so that the control data as output data is generated.

The service-display-setting-screen generation section 67 acquires, from the service setting data storage section 95, the service setting data that is associated with the terminal ID of the digital television 1 which terminal ID is included in the parameter in a request for acquiring the service display setting screen 9. Here, the request for acquiring the service display setting screen 9 is performed, based on the control data, by jumping to the web page according to the URL that includes the terminal ID. Accordingly, the request for acquiring the service display setting screen 9 includes, as a parameter, the terminal ID or data that allows specifying the terminal ID.

The service-display-setting-screen generation section 67 sets, in a session ID of a communication session (HTTP (Hyper Text Transfer Protocol) session) with the digital television 1, information that allows specifying the terminal ID at the sidebar providing server. This allows, in the subsequent communication session, the communication session to be recognized as a communication session with the digital television 1 that has the terminal ID. This makes it possible to specify the service setting data that is associated with the terminal ID.

The service-display-setting-screen generation section 67 generates, as output data, data (e.g., HTML data) of the service display setting screen 9, based on the service setting data acquired. That is, based on the service ID that is included in the service setting data acquired, the service-display-setting-screen generation section 67 generates a screen that allows setting whether or not to display a service corresponding to the service ID in the sidebar.

Receiving a service display setting result, the service setting data updating section 68 acquires the terminal ID that is set in the session ID of the communication session (HTTP session). Then, the service setting data updating section 68 acquires, from the service setting data storage section 95, the service setting data associated with the obtained terminal ID. Further, based on the received service display setting result, the service setting data updating section 68 updates the service setting data thus acquired and stores the updated service setting data into the service setting data storage section 95.

When updating the service setting data, the service setting data updating section 68 stores the updated service setting data into the service setting data storage section 95 in a state such that a flag is attached to the updated service setting data, so that it can be identified whether or not the service setting data is updated.

The service setting reflection processing section 69 receives the service setting data from the digital television and then acquires the terminal ID that is set in the session ID of the communication session (HTTP session). Further, the service setting reflection processing section 69 acquires, from the service setting data storage section 95, the service setting data associated with the acquired terminal ID.

The service setting reflection processing section 69 updates the acquired service setting data based on the received service setting data, and stores the updated service setting data in the service setting data storage section 95. Here, the received service setting data is a set of a service ID and a service setting value. Accordingly, when the service setting data is updated, the service setting reflection processing section 69 specifies customization data in the acquired service setting data, by using as a key the service ID included in the received service setting data. Then, the service setting reflection processing section 69 updates thus specified customization data by the service setting value that is paired with the service ID used as the key.

Though not illustrated, predetermined error processing is performed in a case where, for example, due to disconnection of the communication session, the terminal ID that is set in the session ID cannot be acquired.

According to the arrangement, the sidebar providing service 2 is capable of completing appropriate display data 7 in accordance with the service setting data of the digital television 1 and providing the digital television 1 with the appropriate display data 7. Accordingly, the digital television 1 can execute the sidebar function according to the display data 7 that is appropriately customized. Further, in the digital television 1, whether or not to display the service can be set for each service included in the sidebar. Furthermore, in the digital television 1, information required for providing the service can be set for each service.

As a result, the display data 7 of the sidebar can be customized so that the digital television 1 appropriately executes the sidebar function appropriately.

(Display Data)

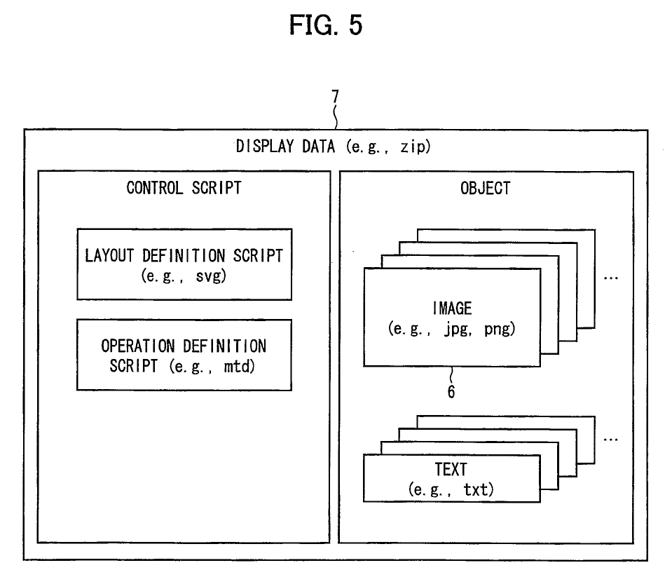

FIG. 5 is a drawing schematically showing a data structure of the display data 7 generated by the display data generation section 63. The display data 7 is information required by the digital television 1 for generating the sidebar. As shown in FIG. 5, the display data 7 in the embodiment of the present invention contains a control script and an object.

The control script specifies an operation taken when the digital television 1 carries out the sidebar function. Namely, a control order with respect to the digital television 1 is included in the control script. The object is data that is to be displayed on the digital television 1, and is specifically, image data in jpg or png format, text data, and the like. As described above, the object includes the image 6 acquired from the service distributing server 3 and the like. Further, in a case where information regarding a brief description of the service is displayed in a text form, text-form data may also be included. Contents of the text data may be (a) customized data generated by the display data generation section 63 in accordance with the contents of the display data request message 5, (b) data included in the pattern data selected by the pattern data selecting section 62, or (c) fixed data.

The data format of the object is not limited to the example shown in FIG. 5, and may be of any data format as long as the digital television 1 can handle the data so as to display the data on the digital television 1.

In the present embodiment, the control script is largely classified into two types.

A first type is a layout definition script, which specifies how and on which position the object is to be displayed. The layout definition script includes how the object to be displayed corresponds to layout information such as a display position and display size of the object. Due to this layout definition script, the digital television 1 knows how and where to display which object in the display data 7.

A second type is an operation definition script, which specifies contents of predetermined operations to be carried out by the digital television 1 in accordance with an event that occurs (e.g. elapse of a predetermined time, start/end of a predetermined operation, receiving display data, or remote control entering by a user) in the digital television 1. The operation definition script defines the operations of the digital television 1 in detail, for example, which of the display data 7 is to be displayed (requested and acquired) subsequently to what kind of event that has occurred. The operation definition script enables the digital television 1 to determine how to process which data at what timing to which device.

The control script may be arranged as, for example, text-form data described by XML (eXtensible Markup Language). Content of the control script can be easily modified and provided to the digital television 1. The layout definition script may be described as, for example, SVG (Scalable Vector Graphics).

As described above, modification of a description in the control script contained in the display data 7 in the sidebar providing server 2 allows easy modification of a specification of the sidebar function to be carried out by the digital television 1, without carrying out any modification to basic functions incorporated in a ROM of the digital television 1.

(Data Format of Service Setting Data)

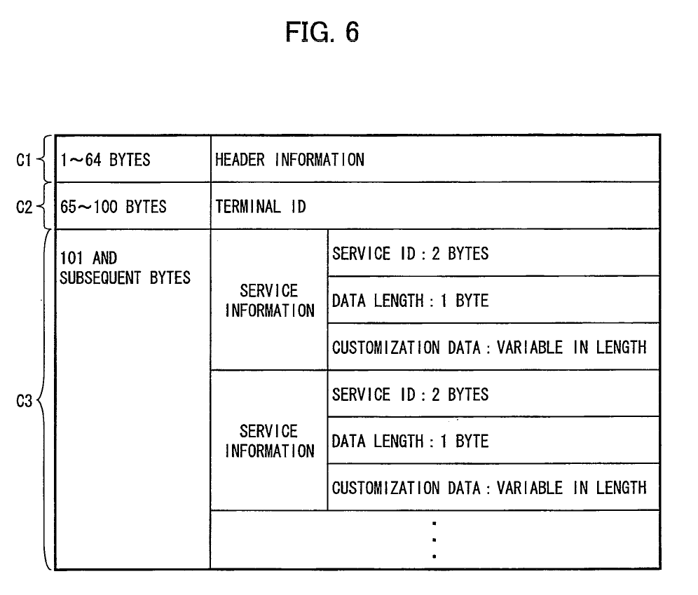

The following description explains a data format of the service setting data, with reference to FIG. 6. FIG. 6 is a schematic drawing showing a data format of the service setting data.

In the present embodiment, service setting data is handled as binary data (fixed length of 1024 bytes). The service setting data includes three blocks (C1 to C3), each of which has a meaning. That is to say, the service setting data includes “header information” as a first block (C1), “terminal ID” as a second block (C2), and “service information” as a third block (C3).

The “header information” is stored from a head of the service setting data, i.e., 1^{st} byte to 64^{th} byte. The “header information” is information for specifying that the data is the service setting data. Additionally, information to be managed by the digital television may also be stored. Note that, even if the service setting data is rewritten to default data, the “header information” will not be rewritten.

The “terminal ID” for identifying the digital television 1 is stored in 65^{th} byte to 100^{th} byte of the service setting data. The “terminal ID” is information described in a format following a legitimate term as follows:

[0-9a-f]{8}−[0-9a-f]{4}−[0-9a-f]{4}−[0-9a-f]{4}−[0-9a-f]{12}

The “service information” is stored in the 101^{st} and subsequent bytes. The “service information” is information that repetitively includes a set of “service ID”, “data length” and “customization data”, for each service.

The “service ID” has a length of 2 bytes, and stores identification information of a service. In the “service ID”, a service ID of a service to be displayed in the sidebar is stored.

The service ID of a minus value is used as an ID reserved for special services. Moreover, the service ID having a value of 0 is used for indicating an end of data.

The “data length” has a length of 1 byte, and stores a value indicating a byte length of following “customization data”.

The “customization data” is changeable in length, and is stored with information (for example ZIP code and the like) required in providing each of the services.

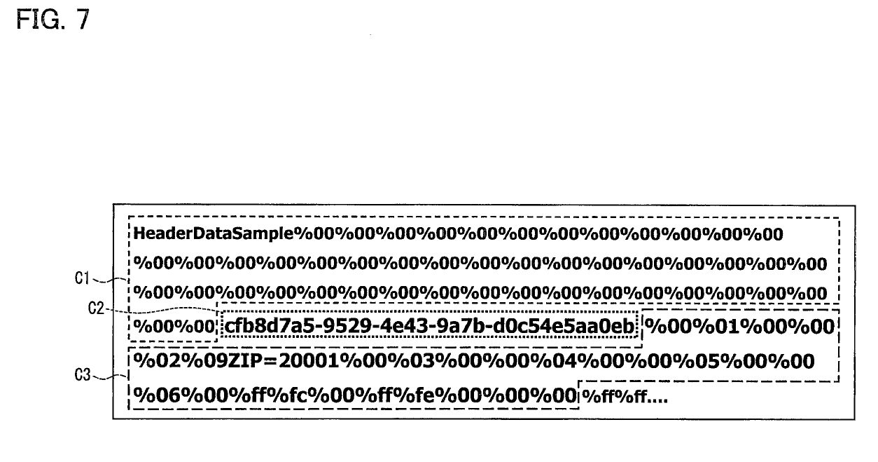

Next is an explanation of an example of data of the service setting data, with reference to FIG. 7. FIG. 7 is a schematic drawing showing an example of data of the service setting data. In this example, the header information includes a text of “HeaderDataSample”. Moreover, a terminal ID of “cfb8d7a5-9529-4e43-9a7b-d0c54e5aa0eb” is included in the terminal ID. In the service information, “1”, “2”, “3”, “4”, “5”, “6”, “−2” and “−4” are included as the service IDs. In addition, a value of “ZIP=20001” is included as the customization data for the service which has the service ID of “2”.

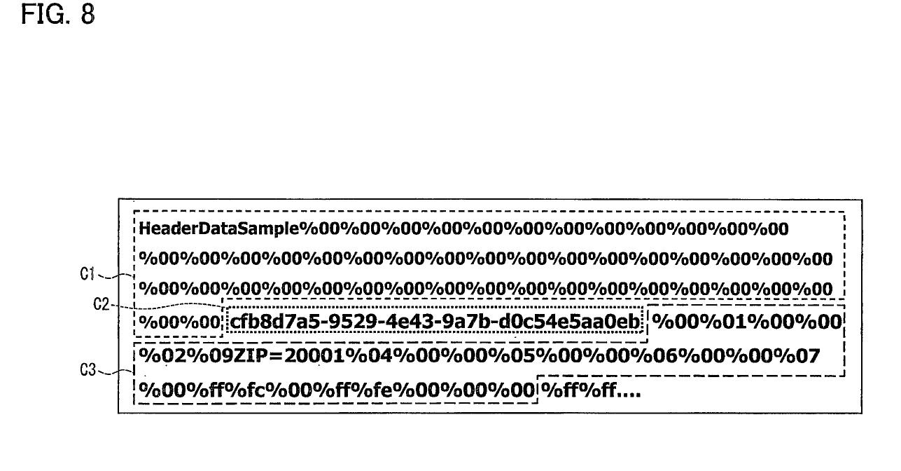

Next provided is an explanation of an example of data of updated service setting data, with reference to FIG. 8. FIG. 8 is a schematic drawing showing an example of another data of service setting data. The example of the data of the service setting data as shown in FIG. 8 is the service setting data as shown in FIG. 7 from which a service having a service ID “3” is deleted and to which a service having a service ID “7” is added. Accordingly, in service setting data, “1”, “2”, “4”, “5”, “6”, “7”, “−2”, and “−4” are included as the service IDs.

[Display Setting of Service to be Included in Sidebar]

(Flow of Series of Processing Steps for Carrying Out Service Display Setting)

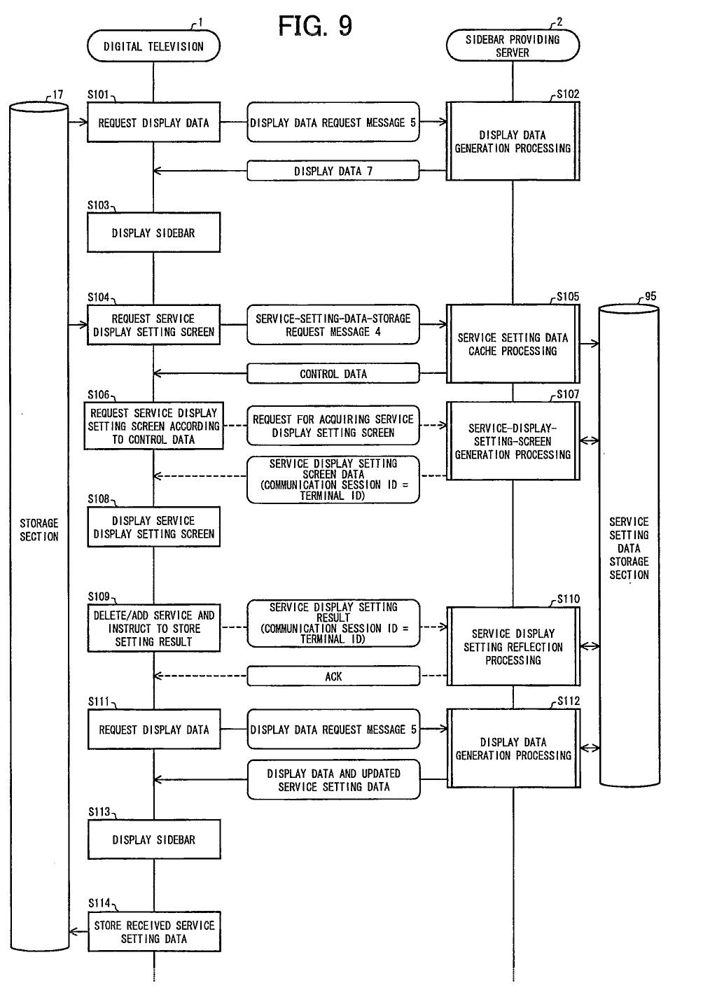

With reference to FIG. 9, provided is an example of a series of processing steps for carrying out display setting of a service to be included in the sidebar. (The display setting of a service means to set display of a service and is also referred to as service display setting.)

First, a processing outline is explained. (1) First, the digital television 1 obtains the display data 7 from the sidebar providing service 2 and displays a sidebar (steps S101 to S103).

(2) For each of a plurality of services displayed in the sidebar, a service display setting screen 9 that allows setting whether or not to display the service is obtained from the sidebar providing server 2 (steps S104 to S108). At this time, the service setting data managed by the digital television 1 is transmitted to the sidebar providing server 2. The transmitted service setting data is temporarily kept by the sidebar providing server 2.

(3) A result (a service display setting result) of setting whether or not to display the service on the service display setting screen 9 is transmitted to the sidebar providing server 2. Then, the sidebar providing server 2 updates thus kept service setting data, based on the service display setting result (steps S109 to S110).

(4) At the end, the digital television 1 obtains the display data 7 that the service providing server 2 generates based on the updated service setting data. Then, the digital television 1 displays a sidebar (steps S111 to S114). At this time, the updated service setting data is transmitted to the digital television 1 and the digital television 1 stores the updated service setting data in the digital television data 1.

Though the digital television 1 stores the service setting data in this way, the digital television 1 does not carry out processing for updating the service setting data. The digital television 1 transmits the service setting data to the sidebar providing server 2, and the sidebar providing service 2 updates the service setting data. Subsequently, updated service setting data is sent back to the digital television 1 and stored in the digital television 1.

Next, each step of the processing flow explained above is explained in detail. First, when the event processing section 30 of the digital television 1 detects an input of an instruction concerning a sidebar display from the operation section 19, the display data request processing section 32 generates a display data request message 5 and transmits the display data request message 5 to the sidebar providing server 2 (the step S101). As explained above, the display data request message 5 includes at least a subject (stating acquisition of the display data 7) and the service setting data that the digital television 1 has.

The sidebar providing server 2 having received the display data request message 5 generates the display data 7 based on the service setting data included in the display data request message 5, and transmits thus generated display data to the digital television 1 (display data generation processing) (the step S102). The display data generation processing is explained later in detail.

Then, the display data execution processing section 33 executes processing of the display data 7 that has been received, when the event processing section 30 of the digital television 1 detects that the display data 7 has been received. In other words, the display data execution processing section 33 displays a sidebar according to a control script included in the display data 7 (the step S103).

Next, service display setting is selected. The service display setting is one of services included in the sidebar. As a result of selecting the service display setting, when the event processing section 30 of the digital television 1 detects an input of an instruction to carry out service display setting, the service-display-setting-screen acquisition processing section 35 first generates a service-setting-data-storage request message 4 and transmits the generated service-setting-data-storage request message 4 to the sidebar providing server 2 (the step S104). The service-setting-data-storage request message 4, as explained above, includes at least a subject (stating storage of the service setting data) and the service setting data that the digital television 1 has.

Then, the sidebar providing server 2 having received the service-setting-data-storage request message 4 stores, in the service setting data storage section 95, the service setting data that is included in the service-setting-data-storage request message 4 (service setting data cache processing) (the step S105). The service setting data cache processing is explained later in detail.

Then, the sidebar providing server 2 transmits, to the digital television 1, control data for making an access to an web page that provides the service display setting screen 9, in response to the service-setting-data-storage request message 4 (the step S105). Here, the control data is a set of (i) a layout script that has a description to jump to the web page according to a URL that includes a terminal ID and (ii) an operation content definition script that has a description to execute the layout definition script.

The service-display-setting-screen acquisition processing section 35 makes a request to the sidebar providing server 2 for acquiring the service display setting screen 9 (the step S106) when the event processing section 30 of the digital television 1 detects that the control data has been received. The request for acquiring the service display setting screen 9 is performed by making an access to the web page that provides the service display setting screen 9, based on the received control data.

Having received the request for acquiring the service display setting screen 9, the service-display-setting-screen generation section 67 generates the service display setting screen 9 and transmits thus generated service display setting screen 9 to the digital television 1 (service-display-setting-screen generation processing (the step S107). The service-display-setting-screen generation processing is explained later in detail.

In the service-display-setting-screen generation processing of the sidebar providing server 2, a terminal ID of the digital television 1 is set in an ID of a current communication session between the digital television 1 and the sidebar providing server 2. This makes it possible to have the communication session recognized as a communication session with the digital television 1 that has the terminal ID, in the subsequent communication sessions. As a result, the service setting data to be processed can be specified.

When the event processing section 30 of the digital television 1 detects that the service display setting screen 9 has been received, the browser processing section 34 displays thus received service display setting screen 9 (the step S108). In the service display setting screen 9, whether to display or not to display a service can be set for each of all the services included in the sidebar. It is preferable that broadcast data and the service display setting screen 9 are displayed so that an area in which the broadcast display is displayed does not overlap an area in which the service display setting screen 9 is displayed.

Next, when the event processing section 30 of the digital television 1 detects an input for storing a result of setting whether or not to display a service in the service display setting screen 9 that is displayed by the browser processing section 34, the browser processing section 34 transmits a service display setting result to the sidebar providing server 2 (the step S109). The transmission of the service display setting result is carried out in the communication session in which the terminal ID of the digital television 1 is set in the service-display-setting-screen generation processing.

When the service display setting result is received, the service setting data updating section 68 updates the service setting data that is stored in the service setting data storage section 95, based on the received service display setting result (service display setting reflection processing) (the step S110). The service display setting reflection processing is explained later in detail.

Next, when the event processing section 30 of the digital television 1 detects again an instruction for display a sidebar is inputted from the operation section 19, the display data request processing section 32 generates the display data request message 5, and transmits thus generated display data request message 5 to the sidebar providing server 2 (the step S111).

The sidebar providing server 2 having received the display data request message 5 generates the display data 7, based on the service setting data included in the display data request message 5, and transmits thus generated display data 7 to the digital television 1 (display data generation processing) (the step S112). At this time, the sidebar providing server 2 also transmits to the digital television 1 the updated service setting data.

Then, when the event processing section 30 of the digital television 1 detects that the display data 7 has been received, the display data execution processing section 33 executes the processing of the received display data 7 (the step S113).

At the end, the digital television 1 stores, in the storage section 17, the updated service setting data received (the step S114).

The communication session between the digital television 1 and the sidebar providing server 2 in the steps S106 to S110 is assumed to be a communication session that is performed by the browser processing section 34 with the use of an HTTP protocol. This makes it possible to carry out generation and display of the service display setting screen 9 by using a predetermined form in an HTML. It also becomes possible to realize transmission of the service display setting result by transmitting data inputted into the form with the use of the HTTP protocol.

In FIG. 9, a sequence shown by the dotted line between the digital television 1 and the sidebar providing server 2 shows an access by a browser. A sequence shown by the solid line shows an access by a dedicated application that is not a browser.

The sidebar display processing explained in the steps S103 and S113 is carried out not by the browser processing section 34 but by the display data execution processing section 33 (dedicated application). In other words, the display processing as explained in the steps S101 to S114 is carried out by sequential processings that are performed by the display data execution processing section 33 and the browser processing section 34, respectively. In the arrangement here, the service setting data is kept in the sidebar providing server 2 so as to correspond to the terminal ID, and the terminal ID is used in a message and/or a parameter in the communication with the sidebar providing server 2. This makes it unnecessary to have an arrangement in which, in the digital television 1, the display data execution processing section 33 and the browser processing section 34 directly exchanges information (coordinate) on the service display setting. The above arrangement allows the display data execution processing section 33 and the browser processing section 34 to exchange information (coordination) on the service display setting via the sidebar providing server 2.

The service setting data of all digital televisions 1 each having transmitted the display data request message 5 is not stored, but a sequence of the above steps S104 and S105 is executed. This makes it possible to store, in the sidebar providing server 2, only the service setting data of the digital television 1 that makes a request for acquiring the service setting screen.

(Flow of Display Data Generation Processing)

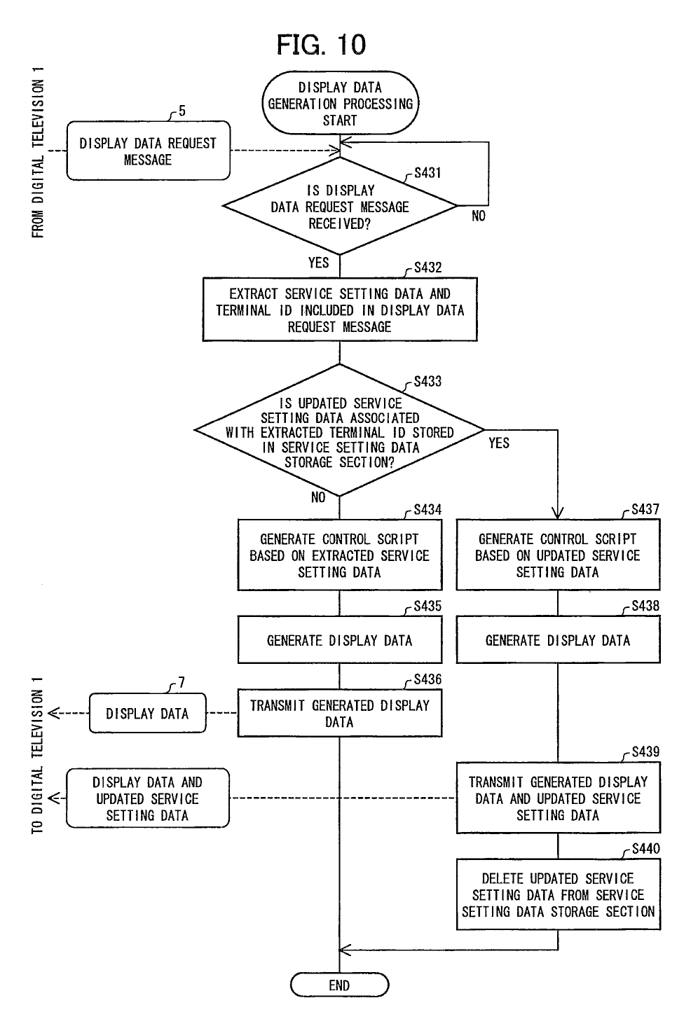

Next, a flow of the display data generation processing is explained with reference to FIG. 10.

Having received the display data request message 5 from the digital television 1 (YES in a step S431), the sidebar providing server 2 extracts the service setting data included in the received display data request message 5 and also extracts the terminal ID from the extracted service setting data (a step S432). Then, the sidebar providing server 3 checks whether or not the updated service setting data associated with the extracted terminal ID is stored in the service setting data storage section 95 (a step S433). Whether or not the service setting data is updated can be checked by checking presence of a flag indicative of update which flag is stored so as to correspond to the service setting data.

In a case where the updated service setting data associated with the extracted terminal ID is not stored in the service setting data storage section 95 (NO in the step S433), based on the service setting data that is extracted from the received display data request message 5, (i) the service image acquiring section 64 acquires an object necessary for generating the display data 7, (ii) the pattern data selecting section 62 selects pattern data for generating the display data 7, and (iii) the control script generation section 80 generates a control script to be included in the display data 7 (a step S434).

Then, the display data generation section 63 generates the display data 7 by combining the generated control script and an object specified by the script that is, for specifying the object, included in the control script (a step S435).

Then, the display data generation section 63 transmits thus generated data 7 to the digital television 1 (a step S436).

Meanwhile, in a case where the updated service setting data associated with the terminal ID that is extracted in the step S433 is stored in the service setting data storage section 95 (YES in the step S433), based on the updated service setting data, (i) the service image acquiring section 64 acquires an object necessary for generating the display data 7, (ii) the pattern data selecting section 62 selects pattern data for generating the display data 7, and (iii) the control script generation section 80 generates the control script to be included in the display data (a step S437).

Then, the display data generation section 63 generates the display data 7 by combining thus generated control script and an object specified by the script that is, for specifying the object, included in the control script (a step S438).

Subsequently, the display data generation section 63 transmits the generated display data 7 to the digital television 1, and also transmits the updated service setting data to the digital television 1 (a step S439).

Then, the display data generation section 63 deletes the updated service setting data from the service setting data storage section 95. In a case where there is no access to the sidebar providing server 2 from the digital television 1, it is preferable that the service setting data stored in the service setting data storage section 95 of the sidebar providing server 2 is automatically deleted when a predetermined period of validity has elapsed (for example, after 24 hours).

(Flow of Service Setting Data Cache Processing)

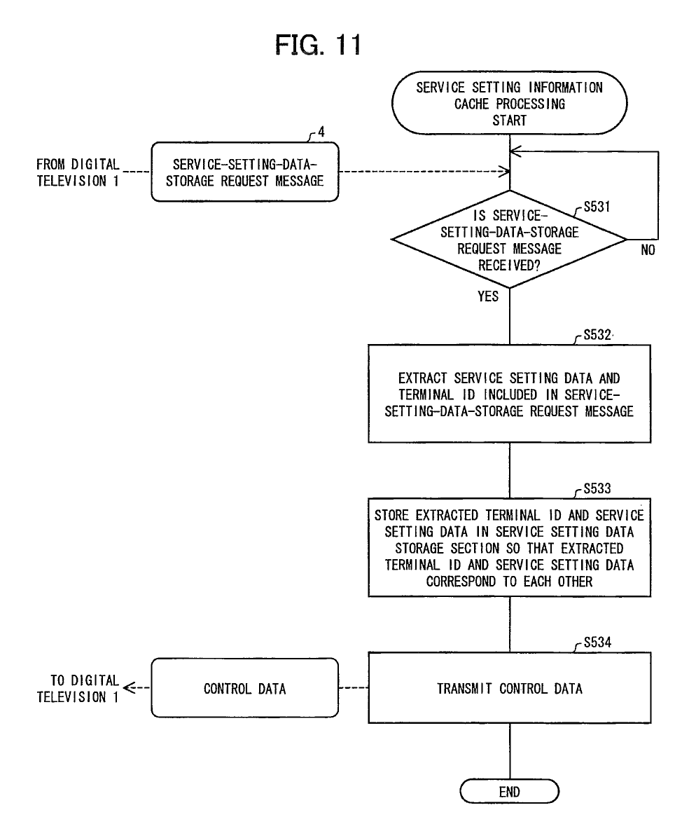

Next, a flow of the service setting data cache processing is explained with reference to FIG. 11.

When the sidebar providing server 2 receives the service-setting-data-storage request message 4 from the digital television 1 (YES in a step S531), the service-setting-data cache processing section 66 extracts the service setting data included in the received service-setting-data-storage request message 4 and further extracts the terminal ID from thus extracted service setting data (a step S532). Then, the service setting data cache processing section 66 stores the extracted terminal ID and the extracted service setting data in the service setting data storage section 95 in a manner such that the terminal ID corresponds to the service setting data (a step S533).

Then, the service-setting-data cache processing section 66 transmits control data to the digital television 1, in response to the received service-setting-data-storage request message 4 (a step S534). The control data is data for making an access to the web page that provides the service display setting screen 9. As explained above, the control data is a set of (i) a layout definition script that describes to jump to the web page according to a URL including the extracted terminal ID and (ii) an operation content definition script that describes to execute the layout definition script.

(Flow of Service-Display-Setting-Screen Generation Processing)

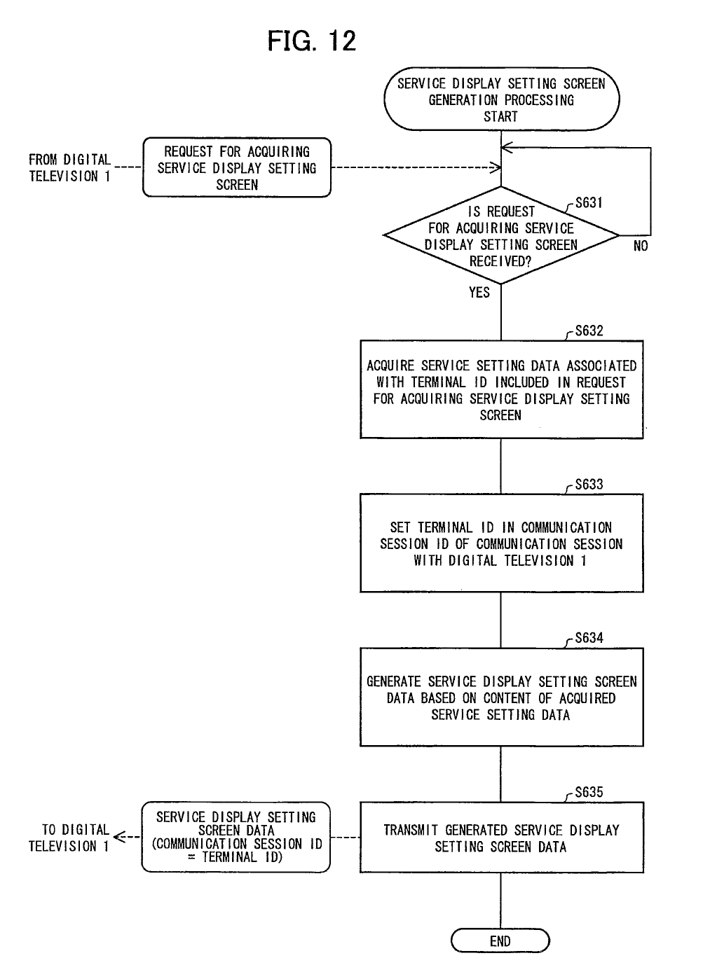

Next, the following explains a flow of the service-display-setting-screen generation processing, with reference to FIG. 12.

When the sidebar providing server 2 receives, from the digital television, a request for acquiring the service display setting screen 9 (YES in a step S631), the service-display-setting-screen generation section 67 acquires, from the service setting data storage section 95, the service setting data associated with the terminal ID of the digital television 1 included in the parameter of the request for acquiring the service display setting screen 9 (a step S632). Here, the request for acquiring the service display setting screen 9 is made based on the control data that is transmitted from the sidebar providing server 2 in the service setting data cache processing. In the digital television 1, as explained above, a web jump is made to a URL including the terminal ID. Accordingly, the terminal ID is included as a parameter in the request for acquiring the service display setting screen 9.

Next, the service-display-setting-screen generation section 67 sets the terminal ID in the session ID of the communication session (HTTP session) with the digital television 1 (a step S633). This allows the communication session to be recognized as a communication session with the digital television 1 that has the terminal ID, in the subsequent sessions. This makes it possible to specify service setting data associated with the terminal ID.

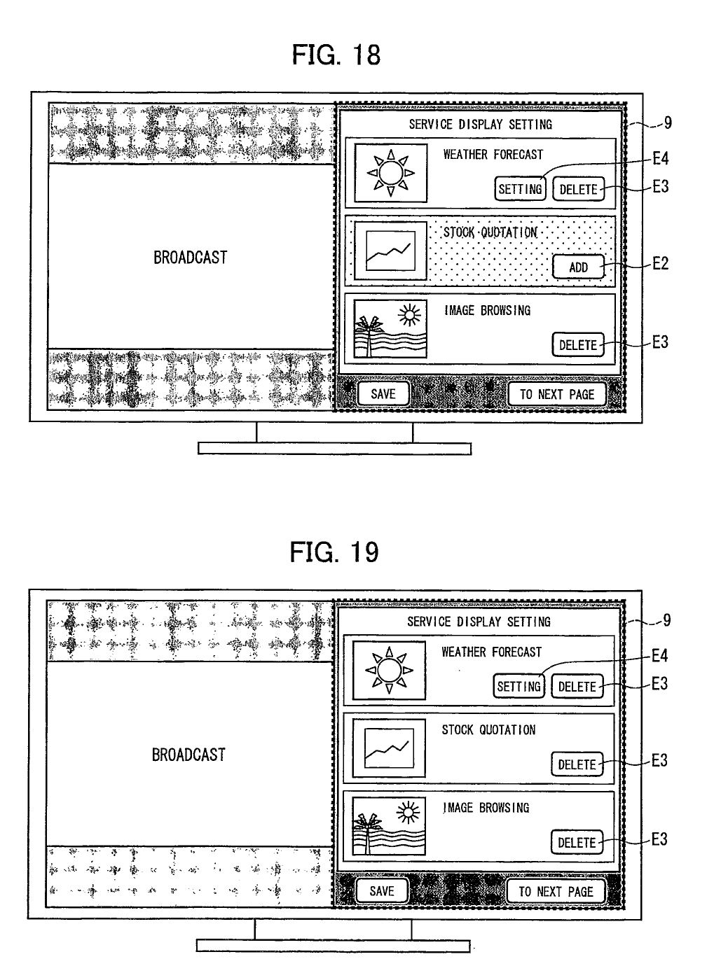

Next, the service-display-setting-screen generation section 67 generates data (e.g., HTML data) of the service display setting screen 9, based on the acquired service setting data (a step S634). That is, based on the service ID included in the acquired service setting data, the service-display-setting-screen generation section 67 generates a screen that allows setting whether or not to display, in a sidebar, a service corresponding to the service ID. For example, the service-display-setting-screen generation section 67 dynamically generates screen data that displays a list of services each corresponding to service IDs included in the acquired service setting data and provides, for each service, a button (for example, a toggle button where “add” and “delete” switches) for setting whether or not to display the service (See FIG. 18). Further, a display based on customization data that is included in the service setting data may be carried out.

Then, the service-display-setting-screen generation section 67 transmits to the digital television 1 the data of thus generated service display setting screen 9 (a step S635).

(Flow of Service Display Setting Reflection Processing)

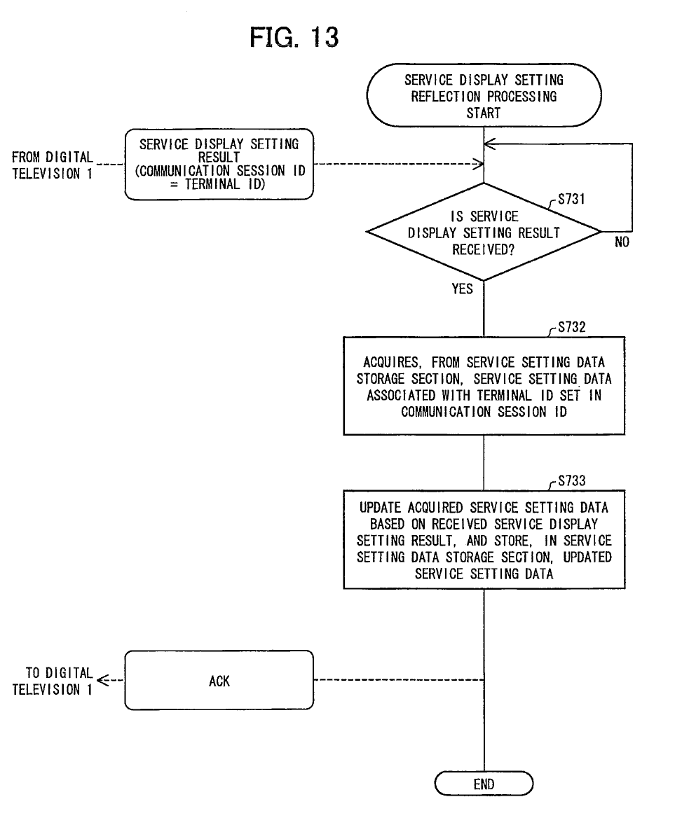

Next, the following explains a flow of the service display setting reflection processing, with reference to FIG. 13.

When the sidebar providing server 2 receives the service display setting result from the digital television 1 (YES in a step S731), the service setting data updating section 68 acquires the terminal ID set in the session ID of the communication session (HTTP session), and acquires, from the service setting data storage section 95, the service setting data associated with the acquired terminal ID (a step S732).

Then, the service setting data updating section 68 updates the acquired service setting data, based on the received service display setting result, and stores thus updated service setting data into the service setting data storage section 95 (a step S733). Here, the received service display setting result is data including a plurality of sets each including a service ID and information indicating whether or not to display a service (for example, “1” indicating to display and “0” indicating not to display). The following is an example of data of the service display setting result.

1=1&2=0&3=0&4=1&−1=1&−2=1.

The above example of data shows a setting result indicating that services having service IDs of “1”, “4”, “−1”, and “−2” are to be displayed and services having service IDs “2” and “3” are not to be displayed.

Accordingly, in a case where, at the time when the service setting data is updated in the step S733, the service setting data does not include, in the received service display setting result, a service ID corresponding to the information indicating that the service is to be displayed, the service setting data updating section 68 adds a service ID to the service setting data. Meanwhile, in a case where the service setting data includes a service ID corresponding to the information indicating not to display the service, the service setting data updating section 68 deletes the service ID from the service setting data.

Further, when the service setting data is updated in the step S733, the updated service setting data in a state such that a flag indicative of update is attached is stored into the service setting data storage section 95. This is for making it possible to identify later whether or not the service setting data has been updated.

Though not illustrated, in a case where, due to disconnection of a communication session, the terminal ID set in the session ID cannot be acquired or in a case where the information indicating to display the service in the service display setting result does not satisfy a predetermined condition (for example, there are more than ten pieces of information each indicating to display a service), predetermined error processing is carried out.

(Example of Screen at Time when Service Display Setting is Performed)

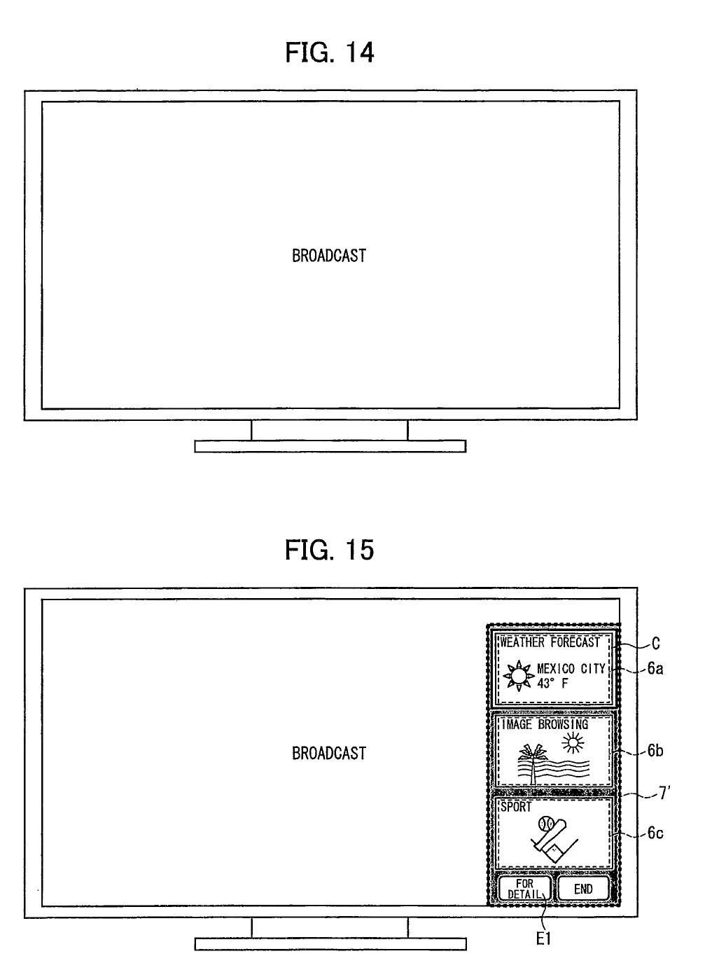

With reference to FIGS. 14 to 21, an example of a screen for display setting of a service to be included in the sidebar is explained.

FIG. 14 is an example of a screen before the processing explained in the above step S101, that is, in a state where the display data 7 is not acquired. FIG. 14 shows that all of the display section 16 displays a received broadcast.

FIG. 15 shows an example of a screen showing a state after processing steps as explained in the steps S101 to S103 are carried out (that is, in a state where a sidebar is displayed) subsequent to the state shown in FIG. 14. This example shows a state in which a sidebar 7′ is displayed in a lower right corner of the display section 16. The sidebar 7′ as shown in FIG. 15 displays an image 6a showing a brief description of a weather forecast service, an image 6b showing a brief description of an image browsing service, and an image 6c showing a brief description of a sport service. Other services that do not appear in the current sidebar become visible by a user operation (e.g., pressing down an up/down button on a remote controller).

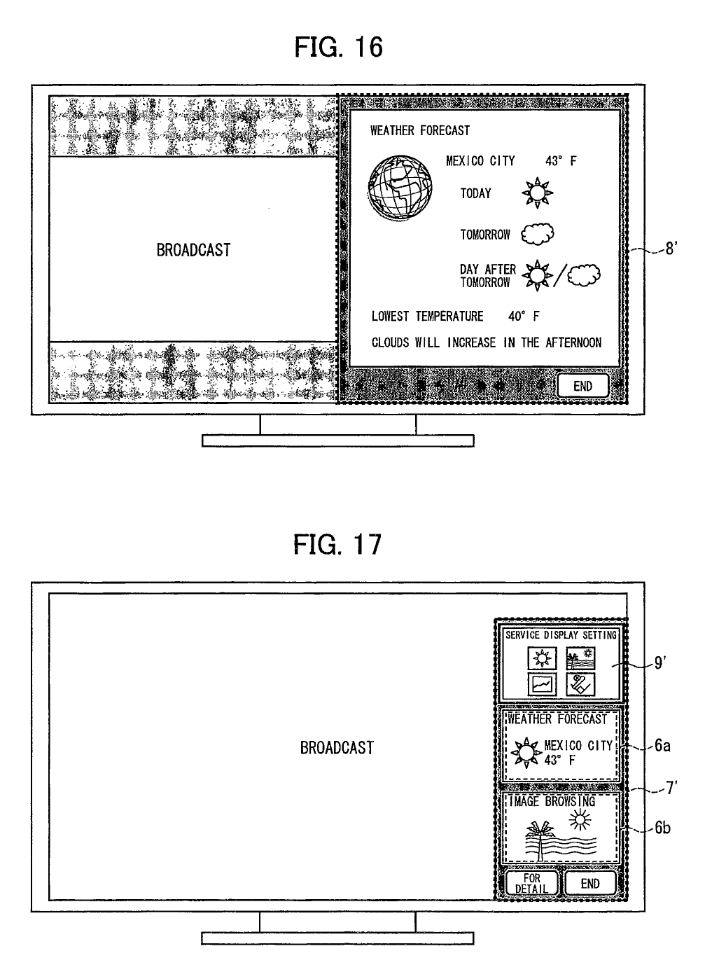

When a button on a remote controller which button is displayed on the screen like E1 is selected in a state where a cursor is on the image 6a (the image indicating the brief description of the weather forecast service), the display data execution processing section 33 calls the browser processing section 34 and makes an instruction to activate the service (in this case the weather forecast service), according to the description in the control script. Then, the browser processing section 34 requests a service 8 from the service distributing service 3. Subsequently, the browser processing section 34 downloads the service 8′ (e.g., HTML data) and displays the service 8′ on the display section 16 of the digital television 1 (FIG. 16). In FIG. 16, the weather forecast service is displayed.

FIG. 17 shows an example of a screen showing a state where an object 9′ for calling the service display setting screen 9 is displayed in the sidebar 7′ as shown in FIG. 15, according to a user operation. When the object 9′ is selected by another user operation, the processing explained in the above steps S104 to S108, that is, display processing of the service display setting screen 9 is executed.

FIG. 18 shows an example of a screen showing a state where the service display setting screen 9 is displayed subsequent to the state shown in FIG. 17. At this time, an area displaying a broadcast is displayed in a manner such that the area is shrank while an aspect ratio is kept the same. As shown in FIG. 18, the service display setting screen 9 is provided with a toggle button in which “add” (E2) and “delete” (E3) switches for each service, so that it becomes possible to set whether or not to display a service in the sidebar.

Here, a “delete” button is provided for a service currently displayed on the sidebar, so that an instruction to switch to non-display can be made for the service. On the other hand, an “add” button is provided for a service that is not currently displayed on the sidebar, so that an instruction to switch to display can be made for the service. In the example as illustrated in FIG. 18, each of the weather forecast service and the image browsing service is provided with a “delete” button, because the weather forecast service and the image browsing service are currently set to be displayed on the sidebar. On the other hand, the “stock quotation” service is provided with an “add” button because the “stock quotation” service is currently set not to be displayed on the sidebar.

FIG. 19 is an example of a screen showing a state after the “add” button in a column of the stock quotation service is pressed down subsequent to the state shown in FIG. 18. Because the “add” button is pressed, a setting of the stock quotation service is switched to a setting according to which the stock quotation service is displayed on the sidebar. Accordingly, the column of the stock quotation service in FIG. 19 shows a state in which a “delete” button is displayed in lieu of the “add” button.

FIG. 20 shows an example of a screen illustrating a state after the processing as explained in the above steps S109 to S110 is carried out (that is, after the service display setting result is reflected to the service setting data kept by the sidebar providing server 2) subsequent to the state as shown in FIG. 19. The screen shows a message such that the service display setting result is stored.

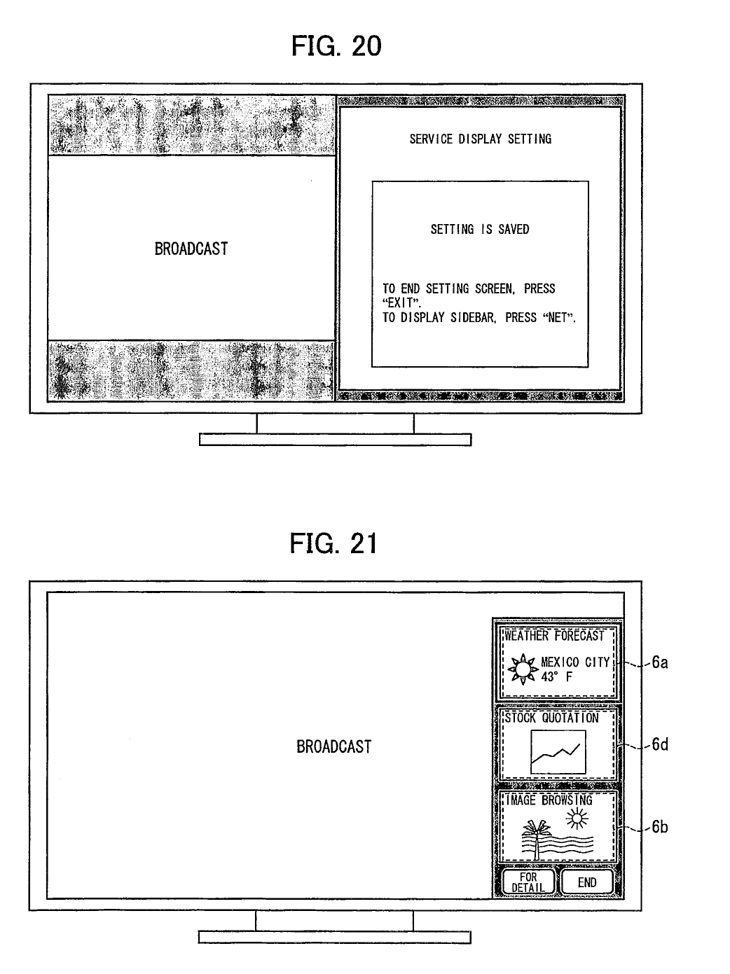

FIG. 21 is an example of an image showing a state after the processing as explained in the above steps S111 and S112 is carried out (that is, a state in which the display data 7 is obtained once again and the sidebar is displayed) subsequent to the state shown in FIG. 20. Because the stock quotation service is set to be displayed as explained above, FIG. 21 shows that the image 6d showing the brief description of the stock quotation service is displayed in the sidebar that is newly displayed this time.

[Service Setting]

Next, explained is processing for setting information required for providing the service, for the purpose of further customizing a service included in the sidebar.

For example, in the case of, for example, the weather forecast service that provides weather forecast of a region according to postal code information (ZIP cod), the “information required for providing the service” is the postal code information. By changing the postal code information, a user can receive the full benefit of the weather forecast of the region shown according to the changed postal code information.

Hereinafter, to set information required for providing a service is also referred to as “service setting”.

[Flow of Processing for Carrying Out Service Setting]

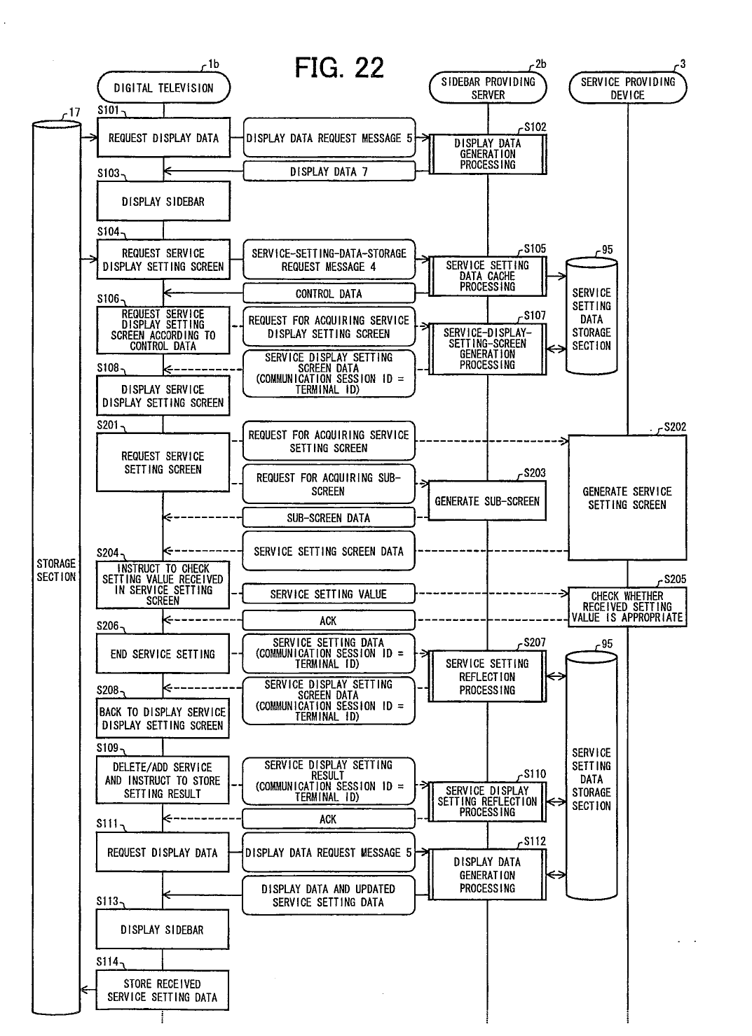

With reference to FIG. 22, explained is an example of a series of processing steps for setting information required for providing a service included in the side bar.

First, a processing outline is explained. (1) A processing flow up to displaying the service display setting screen 9 is the same as a flow including the steps from S101 to S108 explained above, and an explanation thereof is omitted here. Note that, in the service display setting screen 9 explained below, a button for displaying the service setting screen 11 is provided for each service for which setting can be carried out.

(2) By pressing down the button for displaying the service setting screen 11, the service setting screen 11 is displayed and service setting is carried out (steps S201 to S205). Data of the service setting screen 11 (e.g., HTML data) is generated by the service distributing server 3 and provided to the digital television 1.

(3) A result of carrying out the service setting in the service setting screen 11 is transmitted to the sidebar providing server 2. Based on this result, the sidebar providing server 2 updates the service setting data kept by the sidebar providing server 2 and updates the service display setting screen 9 (steps S206 to S208).

(4) Next, a flow that is the same as a flow including the steps from S109 to S114 explained above is performed as a subsequent flow from a processing in which the sidebar providing server 2 updates the service setting data kept by the sidebar providing server 2, based on the result of the service display setting carried out in the service display setting screen 9 to a processing in which the digital television 1 acquires the display data generated based on the updated service setting data and displays a sidebar. An explanation of this processing flow is omitted here.

The following explains in detail the processing flow including the steps from S201 to S208.

When the event processing section 30 of the digital television 1 detects an input of an instruction to carry out service display setting from the operation section 19, the browser processing section 34 makes a request, to the service distributing service 3, for acquiring the service setting screen 11 (the step S201). The request for acquiring the service setting screen 11 includes, as a parameter, a current setting value of data for performing service setting. In the case of, for example, the above weather forecast service, a current setting value of the postal code information (i.e., ZIP code) is included in the parameter.

The request for acquiring the service setting screen 11 is made by making an access to the web page that provides the service setting screen 11 in the service distributing server 3 that provides the service.

At the same time as making the request, the browser processing section 34 may request other auxiliary screen (sub-screen) that is to be displayed concurrently with the service setting screen 11 from the sidebar providing server 2. The sub-screen is, for example, a screen that is displayed next to the service setting screen 11 and provides various information.

In response to the request for acquiring the service setting screen 11, the service distributing server 3 generates data (e.g., HTML data) of the service setting screen 11 according to a generally known method, and transmits thus generated data of the service setting screen 11 to the digital television 1 (the step S202). At this time, it is preferable that the current value of data for carrying out service setting in the parameter of the request for acquiring the service setting screen 11 is arranged to be displayed on the service setting screen 11.

In a case where a request for the sub-screen is made to the sidebar providing server 2, the sidebar providing server 2 generates sub-screen data (e.g., HTML data) according to the generally known method in response to the request, and transmits thus generated sub-screen data to the digital television 1 (the step S203).

When the digital television 1 receives the data of the service setting screen 11, the digital television 1 displays thus received data of the service setting screen 11 and a separately acquired broadcast next to each other. The digital television 1 may display the sub-screen received from the sidebar providing server 2 together with the service setting screen 11. At this time, the screen may be divided into two frames, so that the service setting screen 11 is displayed on one of the frames and the sub-screen is displayed on the other frame.

When the event processing section 30 of the digital television 1 detects an input of an instruction to check the setting value at the time when an input of a setting value of data for carrying out the service setting is received in the service setting screen 11, the browser processing section 34 transmits thus inputted setting value (service setting value) to the service distributing server 3 (the step S204). This is for checking, in the service distributing server 3, whether or not the service setting value inputted is appropriate.

Then, the service distributing server 3 having received the service setting value checks whether or not the service setting value is appropriate (the step S205). When the service setting value is found to be not appropriate as a result of the check, the service distributing server 3 carries out predetermined error processing (for example, transmits, to the digital television, an error display screen indicating that the service setting value is not appropriate).

When the event processing section 30 of the digital television 1 detects an input of an instruction to store the service setting value in the service setting screen 11 in a case where the service setting value is found to be appropriate as a result of the check, the browser processing section 34 transmits, to the sidebar providing server 2, a set of the service setting value and a service ID of a service for which the service setting is carried out (service setting data) (the step S206). This is for updating the service setting data in the sidebar providing server 2.

The processing in the step S206 may be carried out as follows. That is, in the step S205, the service distributing server 3 may send, to the digital television 1, a response that instructs redirection to the sidebar providing server 2, as a result of checking whether or not the service setting value is appropriate. Consequently, based on the instruction of the redirection, an access from the digital television 1 to the sidebar providing server 2 may be automatically made.

Then, the sidebar providing server 2 having received the service setting data updates, based on the received service setting data, the service setting data stored in the service setting data storage section 95 (service setting reflection processing) (the step S207). The service setting reflection processing is explained later in detail. As a result of the service setting reflection processing, the sidebar providing server 2 generates data of the service display setting screen 9 once again based on the updated service setting data, and transmits thus generated data to the digital television 1.

In the above processing flow, the service distributing server 3 is arranged to check whether or not the service setting value is appropriate. Alternatively, by making no inquiry to the service distributing server 3, for example, the digital television 1 may check the service setting value which the digital television 1 can check with the use of, for example, JavaScript (e.g., when it is checked whether or not the postal code information inputted is the number in a case where the service setting value is postal code information).

The communication session between (i) the digital television 1 and (ii) the sidebar providing server 2 and the service distributing service 3 in the steps S201 to S206 is assumed to be a communication session that uses an HTTP protocol. At this time, it is preferable to carry out the communication, after data is concealed by HTTPS (Hyper Text Transfer Protocol Security).

This allows using a predetermined form in the HTML, for generation and display of the service setting screen 11. Moreover, transmission of the service setting data can be realized by transmitting, with the use of the HTTP protocol, data inputted into the form.

In FIG. 22, a sequence shown by a dotted line between the digital television 1 and the sidebar providing server 2 shows an access by a browser. Meanwhile, a sequence shown by a solid line shows an access by dedicated application that is not a browser.

The processing flow explained above allows exchange of the setting value (coordination) between the sidebar providing server 2 and the service distributing server 3.

(Flow of Service Setting Reflection Processing)

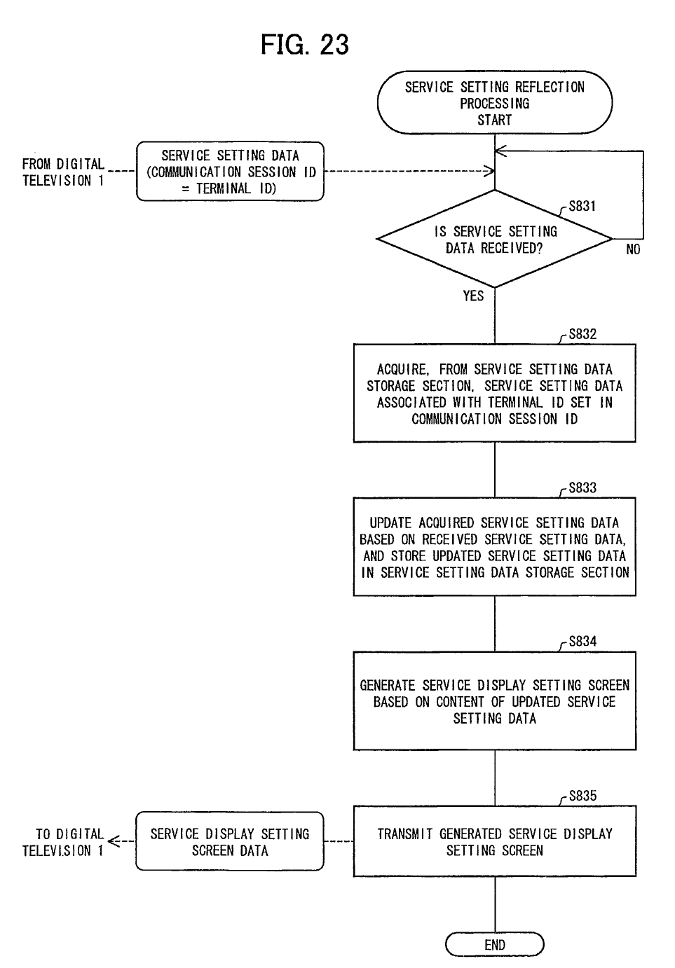

The following explains a flow of the service setting reflection processing with reference to FIG. 23.

When the sidebar providing server 2 receives the service setting data from the digital television 1 (YES in a step S831), the service setting reflection processing section 69 acquires a terminal ID set in the session ID of the communication session (HTTP session) and also acquires, from the service setting data storage section 95, service setting data associated with thus acquired terminal ID (a step S832).

Then, the service setting reflection processing section 69 updates, based on the received service setting data, the acquired service setting data, and stores thus updated service setting data into the service setting data storage section 95 (a step S833). Here, thus received service setting data is a set of a service ID and a service setting value. Accordingly, when the service setting data is updated in the step S833, the service setting reflection processing section 69 specifies customization data in the acquired service setting data by using as a key the service ID in the received service setting data. Then, the service setting reflection processing section 69 updates the specified customization data by the service setting value that is paired with the service ID used as the key.

Though not illustrated, in a case where, due to disconnection of a communication session, the terminal ID set in the session ID cannot be acquired or the like, predetermined error processing is carried out.

(Example of Screen for Service Setting Reflection Processing)

With reference to FIGS. 18, 19, 24, and 25, an example of a screen for carrying out service setting is explained.

As shown in FIGS. 18 and 19, the service display setting screen 9 is provided, for a service for which the service setting can be carried out, with a “setting” button (E4) for calling the service setting screen 11, in addition to a toggle button in which “add” (E2) and “delete” (E3) switches and which toggle button allows setting whether or not to display a service in the sidebar. In this example, the “setting” button is provided to the weather forecast service in which postal code information can be set. By pressing down the “setting” button, the screen shifts to the service setting screen 11 as shown in FIG. 24.

FIG. 24 is an example of a screen showing a state where the service setting screen 11 is displayed. As shown in FIG. 24, the service setting screen 11 is provided with a form that allows setting information necessary for providing a service. In this example, an input form for allowing setting a value of postal code information (ZIP code) is provided. In this example, by pressing down a “CHECK” button (E5), an instruction to check whether or not the setting value is appropriate is made with respect to the service distributing service 3 as explained in the above step S204. Moreover, in this example, by pressing down a “DONE” button (E6), service setting data is transmitted to the sidebar providing server 2 as explained in the above step S206.

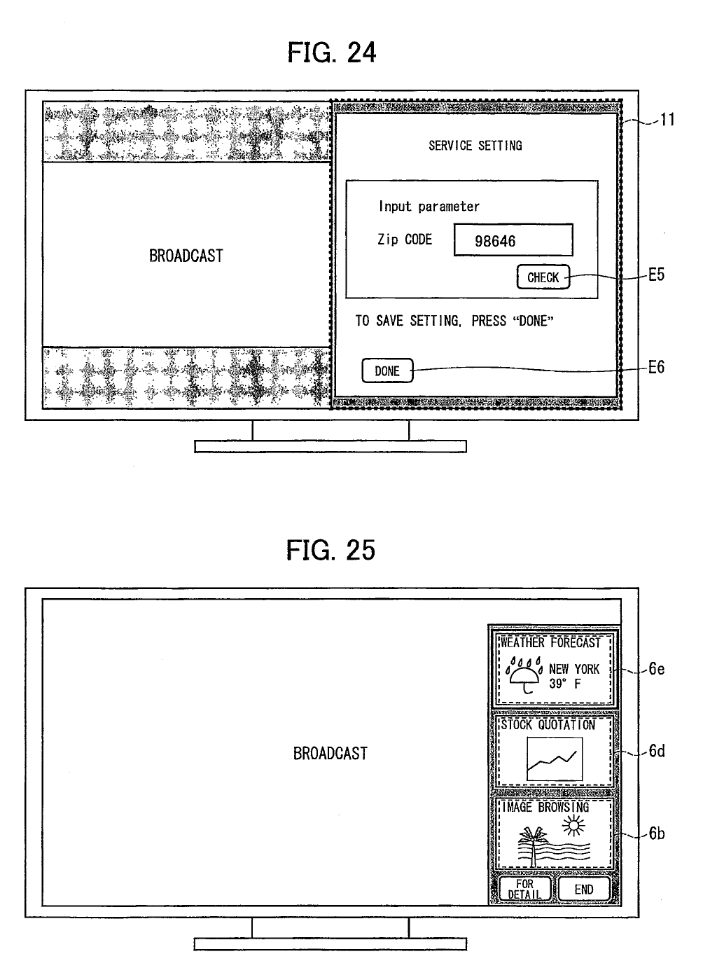

FIG. 25 is an example of a screen showing a state after the processing explained in the above steps S111 and S112 has been carried out (that is, a state where the display data 7 is acquired once again after the service setting is carried out and a sidebar is displayed). In a case where a value of the ZIP code is changed in FIG. 24, an image indicating the brief description of the weather forecast service is changed in FIG. 25 according to the change. The present example shows a state where a value of the ZIP code is changed to a value indicating the New York region so that the weather forecast of the New York region is displayed.

(Additional Matters)

Finally, the control sections 10 and 60 may be realized by way of hardware or software as executed by a CPU. In a case where the control sections 10 and 60 are realized by way of software, the digital television 1 and the sidebar providing server 2 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the digital television 1 and the sidebar providing server 2 a computer-readable storage medium containing control program code (executable program, intermediate code program, or source program) for the digital television 1 and the sidebar providing server 2, which is software realizing the aforementioned functions, in order for the computer (or CPU, MPU) to retrieve and execute the program code contained in the storage medium.

The storage medium may be, for example, a tape, such as a magnetic tape or a cassette tape; a disk including a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The digital television 1 and the sidebar providing server 2 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically.

The present invention is not limited to the description of the embodiments above, but may be altered by a skilled person within the scope of the claims. An embodiment based on a proper combination of technical means disclosed in different embodiments is encompassed in the technical scope of the present invention.

### EFFECT OF THE INVENTION

As explained above, an information providing device of the present invention includes: service setting data storage section that stores, in a first storage section, service setting data in which service identification information of at least one service provided to an information display device corresponds to display attribute information indicating whether or not to display an object showing a brief description of the service identified by the service identification information, the service setting data being transmitted from the information display device; display information reception section that receives, from the information display device, display information indicating, for each of the at least one service, whether or not to display the object on the information display device;

service setting data update section that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section; display data generation section that, in response to a request from the information display device, generates: display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and display data transmission section that transmits, to the information display device, the display data generated.

Further, an information providing method includes the steps of: storing, in a first storage section, service setting data in which service identification information of at least one service provided to an information display device corresponds to display attribute information indicating whether or not to display an object showing a brief description of the service identified by the service identification information, the service setting data being transmitted from the information display device; receiving, from the information display device, display information indicating, for each of the at least one service, whether or not to display the object on the information display device; updating, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section; in response to a request from the information display device, generating: display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and transmitting, to the information display device, the display data generated.

The above arrangement allows updating, according to the display information received from the information display device, the service identification information included in the service setting data that is received from the information display device and stored in the first storage section. The arrangement also makes it possible to generate the display data according to the updated service setting data in response to the request from the information display device.

Accordingly, it becomes possible to transmit, to the information display device, the display data on which whether or not to display the object on the information display device is reflected.

Further, update of the service setting data becomes possible in the first storage section, even in a case where, for example, a function (e.g., web browser) of the information display device which function updates the service setting data and a function (e.g., dedicated application) of the information display device which function makes a reference to the service setting data cannot directly exchange the service setting data. Moreover, it becomes possible to share the service setting data between the functions, by making it possible to acquire, from the first storage section, the display data generated based on the updated service setting data.

The information providing device of the present invention further includes: display setting interface providing section that causes the information display device to provide a first user interface through which the display information is inputted, the display information reception section receiving the display information inputted through the first user interface.

According to the arrangement, the first user interface can be displayed on the information display device. Moreover, display information inputted through the first user interface can be received.

Accordingly, it becomes possible to receive the display information that a user of the information display device inputs through the first user interface. For example, it becomes possible to receive the display information that is accepted by a function (e.g., web browser) of the information display device which function displays the first user interface can be received. As a result, the service setting data stored in the first storage section can be updated.

Therefore, the display data on which the display information that a user of the information display device inputs is reflected can be transmitted to the information display device.

Further, for example, it becomes possible to share the service setting data on which the display information inputted by a user is reflected, between a function (e.g., web browser) of the information display device which function displays the first user interface and a function (e.g., dedicated application) of the information display device which function makes a reference to the service setting data.

The information providing device of the present invention may further include: setting information update section that, when the service identification information and setting information are received from the information display device, stores, in the first storage section, the setting information received, so that the setting information received corresponds to the service identification information included in the service setting data stored in the first storage section and corresponding to the service identification information received, the setting information being for acquiring information concerning the service from the service providing device that transmits information on the service to the information display device, the service setting data including the setting information so that the setting information corresponds to the service identification information.

According to the arrangement, when the service identification information and the setting information are received from the information display device, the received setting information can be stored in the first storage section so as to correspond to the received service identification information that is included in the service setting data stored in the first storage section.

Accordingly, the service setting data stored in the first storage section can be updated so as to include the setting information.

Therefore, the display data on which the setting information is reflected can be transmitted to the information display device.

Further, the service setting data on which the setting information is reflected can be shared between functions (e.g., web browser and dedicated application) of the information display device.

In the information providing device of the present invention: the setting information may be inputted through a second user interface that the service providing device causes the information display device to provide.

According to the arrangement, the setting information can be inputted through the second user interface that the information providing device causes the information display device to display.

Accordingly, when the service identification information and the setting information that a user of the information display device inputs through the second user interface are received from the information display device, the service setting data stored in the first storage section can be updated so as to include the received setting information. For example, according the setting data that a function (e.g., web browser) of the information display device displaying the second interface accepts, the service setting data stored in the first storage section can be updated.

Therefore, the display data on which the setting information inputted by a user of the information display device is reflected can be transmitted to the information display device.

Further, for example, the service setting data on which the setting information inputted by the user is reflected can be shared between a function (e.g., web browser) of the information display device which function displays the second user interface and the function (e.g., dedicated application) of the information display device which function makes a reference to the service setting data.

The information providing device of the present invention may further include: service setting data transmission section that, in a case where the service setting data stored in the first storage section has been updated, transmits the service setting data updated to the information display device at the time when the display data transmission section transmits the display data to the information display device.

According to the arrangement, in a case where the service setting data stored in the first storage section has been updated, the updated service setting data can be transmitted to the information display device.

Accordingly, it becomes possible to transmit, to the information display device, the service setting data updated based on the display information or the setting information. Therefore, it is possible to store, in the information display device, the service setting data updated based on the display information and the setting information. As a result, when the information display device makes a request for the display data after the storage of the updated service setting data, the information display device can include, in the request, the service setting data updated based on the display information or the setting information.

Accordingly, once the service setting data is updated based on the display information or the setting information, thereafter, it becomes possible to display, on the information display device, the object on which the content of the update is reflected.

An information display device of the present invention includes: service-setting-data-storage request section that requests the information providing device to store, in the information providing device, the service setting data stored in the second storage section of the information display device; display information transmission section that transmits to the information providing device the display information, so that the service setting data stored in the information providing device is updated; display data request section that makes a request for the display data generated based on the service setting data updated, to the information providing device; and display data reception section that displays the object included in the display data acquired on a display section of the information display device, according to the control script that is included in the display data acquired from the information providing device in response to the request.

According to the arrangement, it is possible to request the information providing device to store, in the information providing device, the service setting data stored in the second storage section of the information display device. Moreover, for updating the service setting data stored in the information providing device, the display information can be transmitted to the information providing device. Further, it becomes possible to make a request to the information providing device for the display data generated based on the updated service setting data. In addition, the object included in the acquired display data can be displayed on the display section of the information display device, according to the control script included in the display data that is acquired from the information providing device in response to the request.

This makes it possible to update the service setting data stored in the information providing device based on the display information. Further, the object can be displayed on the information display device by acquiring the display data generated based on the updated service setting data.

Accordingly, it becomes possible to acquire the display data on which whether or not to display the object on the information display device is reflected and to display the object on the information display device.

Further, update of the service setting data becomes possible in the first storage section, for example, even in a case where a function (e.g., web browser) of the information display device which function updates the service setting data and a function (e.g., dedicated application) of the information display device which function makes a reference to the service setting data cannot directly exchange the service setting data. Moreover, it becomes possible to share the service setting data between the functions, by making it possible to acquire, from the first storage section, the display data generated based on the updated service setting data.

An information display device of the present invention includes: service-setting-data-storage request section that requests the information providing device to store, in the information providing device, the service setting data stored in the second storage section of the information display device; display information transmission section that transmits to the information providing device the display information so that the service setting data stored in the information providing device is updated; display data request section that makes a request for the display data generated based on the service setting data updated, to the information providing device; display data reception section that displays the object included in the display data acquired on a display section of the information display device, according to the control script that is included in the display data acquired from the information providing device in response to the request; and setting information transmission section that transmits, to the information providing device, information including the service identification information and the setting information.

According to the arrangement, it is possible to request the information providing device to store, in the information providing device, the service setting data stored in the second storage section of the information display device. Moreover, for updating the service setting data stored in the information providing device, the display information can be transmitted to information providing device. Further, it becomes possible to make a request to the information providing device for the display data generated based on the updated service setting data. In addition, the object included in the acquired display data can be displayed on a display section of the information display device, according to the control script included in the display data that is acquired from the information providing device in response to the request. Further, information including the service identification information and the setting information can be transmitted to the information providing device.

This makes it possible to update the service setting data stored in the information providing device, based on the display information and the setting information. Further, the object can be displayed on the information display device by acquiring the display data generated based on the updated service setting data.

Accordingly, it becomes possible to acquire (i) the display data on which whether or not to display the object on the information display device and (ii) the setting information is reflected and to display the object on the information display device.

An information display device of the present invention includes: service-setting-data-storage request section that requests the information providing device to store, in the information providing device, the service setting data stored in the second storage section of the information display device; display information transmission section that transmits to the information providing device the display information so that the service setting data stored in the information providing device is updated; display data request section that makes a request for the display data generated based on the service setting data updated, to the information providing device; display data reception section that displays the object included in the display data acquired on a display section of the information display device, according to the control script that is included in the display data acquired from the information providing device in response to the request; and service setting data reception section that stores, in the second storage section, the service setting data received from the information providing device.

According to the arrangement, it is possible to request the information providing device to store, in the information providing device, the service setting data stored in the second storage section of the information display device. Moreover, for updating the service setting data stored in the information providing device, the display information can be transmitted to the information providing device. Further, it becomes possible to make a request to the information providing device for the display data generated based on the updated service setting data. In addition, the object included in the acquired display data can be displayed on a display section of the information display device, according to the control script included in the display data that is acquired from the information providing device in response to the request. Further, the service setting data received form the information providing device can be stored in the second storage section.

This makes it possible to acquire and store the service setting data updated, in the information providing device, based on the display information. Therefore, when a request for the display data is made after the storage of the updated service setting data, the service setting data updated based on the display information can be included in the request.

Accordingly, once the service setting data is updated based on the display information, thereafter, it becomes possible to display the object on which the content of the update is reflected can be displayed on the information display device.

An information providing system of the present invention includes the information providing device and the information display device.

According to the arrangement, the information providing device can store, in the first storage section, at least the service setting data transmitted from the information display device. Moreover, the display information can be received from the information display device. Further, when the display information is received, the service setting data stored in the first storage section can be updated so that (i) the object that is indicated to be displayed is displayed and (ii) the object that is not to be displayed is not displayed. Moreover, in response to the request from the information display device, the display data can be transmitted to the information display device. Furthermore, in a case where the service setting data stored in the first storage section has been updated, the display data can be generated based on the updated service setting data. In a case where the service setting data stored in the first storage section has not been updated, the display data can be generated based on the service setting data included in the request.

The information display device can request the information providing device to store, in the information providing device, the service setting data stored in the second storage section of the information display device. Moreover, for updating the service setting data stored in the information providing device, the display information can be transmitted to the information providing device. Further, the information display device can make a request for the display data generated based on the updated service setting data, to the information providing device. The information display device can display, on a display section of the information display device, the object included in the acquired display data, according to the control script that is included in the display data acquired from the information providing device in response to the request.

Therefore, the information providing device can store the service setting data received from the information display device and update the stored service setting data based on the display information received from the information display device. In addition, the information display device can acquire the display data generated based on the service setting data and display the object on the information display device.

Accordingly, based on the service setting data updated in the information providing device, the information display device can display the object on the information display device.

Further, update of the service setting data becomes possible in the first storage section, even in a case where, for example, a function (e.g., web browser) of the information display device which function updates the service setting data and a function (e.g., dedicated application) of the information display device which function makes a reference to the service setting data cannot directly exchange the service setting data. Moreover, it becomes possible to share the service setting data between the functions, by making it possible to acquire, from the first storage section, the display data generated based on the updated service setting data.

### INDUSTRIAL APPLICABILITY

The present invention is applicable to (i) information display devices which display various information and (ii) information providing devices which provide data to be displayed on the information display devices. Particularly, the present invention is suitably used for (i) information providing devices which provide, to information display devices, brief description information on one or more than one service provided by service providing devices and (ii) information display devices through which a user can customize the brief description information of the service.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An information providing device comprising:
service setting data storage means that stores, in a first storage section, service setting data in which service identification information of at least one service provided to an information display device corresponds to display attribute information indicating whether or not to display an object showing a brief description of the service identified by the service identification information, the service setting data being transmitted from the information display device;
display information reception means that receives, from the information display device, display information indicating, for each of the at least one service, whether or not to display the object on the information display device;
service setting data update means that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section;
display data generation means that, in response to a request from the information display device, generates:
display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and
display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and
display data transmission means that transmits, to the information display device, the display data generated.

2. The information providing device as set forth in claim 1 further comprising:
display setting interface providing means that causes the information display device to provide a first user interface through which the display information is inputted,
the display information reception means receiving the display information inputted through the first user interface.

3. The information providing device as set forth in claim 1, further comprising:
setting information update means that, when the service identification information and setting information are received from the information display device, stores, in the first storage section, the setting information received, so that the setting information received corresponds to the service identification information included in the service setting data stored in the first storage section and corresponding to the service identification information received, the setting information being for acquiring information concerning the service from the service providing device that transmits information on the service to the information display device,
the service setting data including the setting information so that the setting information corresponds to the service identification information.

4. The information providing device as set forth in claim 3, wherein:
the setting information is inputted through a second user interface that the service providing device causes the information display device to provide.

5. The information providing device as set forth in claim 1, further comprising:
service setting data transmission means that, in a case where the service setting data stored in the first storage section has been updated, transmits the service setting data updated to the information display device at the time when the display data transmission means transmits the display data to the information display device.

6. An information display device comprising:
service-setting-data-storage request means that requests the information providing device as set forth in claim 1 to store, in the information providing device, the service setting data stored in the second storage section of the information display device;
display information transmission means that transmits to the information providing device the display information, so that the service setting data stored in the information providing device is updated;
display data request means that makes a request for the display data generated based on the service setting data updated, to the information providing device; and
display data reception means that displays the object included in the display data acquired on a display section of the information display device, according to the control script that is included in the display data acquired from the information providing device in response to the request.

7. An information display device comprising:
service-setting-data-storage request means that requests the information providing device as set forth in claim 3 to store, in the information providing device, the service setting data stored in the second storage section of the information display device;
display information transmission means that transmits to the information providing device the display information so that the service setting data stored in the information providing device is updated;
display data request means that makes a request for the display data generated based on the service setting data updated, to the information providing device;
display data reception means that displays the object included in the display data acquired on a display section of the information display device, according to the control script that is included in the display data acquired from the information providing device in response to the request; and
setting information transmission means that transmits, to the information providing device, information including the service identification information and the setting information.

8. An information display device comprising:
service-setting-data-storage request means that requests the information providing device as set forth in claim 5 to store, in the information providing device, the service setting data stored in the second storage section of the information display device;
display information transmission means that transmits to the information providing device the display information so that the service setting data stored in the information providing device is updated;
display data request means that makes a request for the display data generated based on the service setting data updated, to the information providing device;
display data reception means that displays the object included in the display data acquired on a display section of the information display device, according to the control script that is included in the display data acquired from the information providing device in response to the request; and
service setting data reception means that stores, in the second storage section, the service setting data received from the information providing device.

9. An information providing system comprising an information providing device and an information display device,
the information providing device comprising:
service setting data storage means that stores, in a first storage section, service setting data in which service identification information of at least one service provided to an information display device corresponds to display attribute information indicating whether or not to display an object showing a brief description of the service identified by the service identification information, the service setting data being transmitted from the information display device;
display information reception means that receives, from the information display device, display information indicating, for each of the at least one service, whether or not to display the object on the information display device;
service setting data update means that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section;
display data generation means that, in response to a request from the information display device, generates:
display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and
display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and
display data transmission means that transmits, to the information display device, the display data generated, and
the information display device comprising:
service-setting-data-storage request means that requests the information providing device to store, in the information providing device, the service setting data stored in the second storage section of the information display device;
display information transmission means that transmits to the information providing device the display information, so that the service setting data stored in the information providing device is updated;
display data request means that makes a request for the display data generated based on the service setting data updated, to the information providing device; and
display data reception means that displays the object included in the display data acquired on a display section of the information display device, according to the control script that is included in the display data acquired from the information providing device in response to the request.

10. An information providing method comprising the steps of:
storing, in a first storage section, service setting data in which service identification information of at least one service provided to an information display device corresponds to display attribute information indicating whether or not to display an object showing a brief description of the service identified by the service identification information, the service setting data being transmitted from the information display device;
receiving, from the information display device, display information indicating, for each of the at least one service, whether or not to display the object on the information display device;
updating, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section;
in response to a request from the information display device, generating:
display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and
display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and
transmitting, to the information display device, the display data generated.

11. A program causing a computer in an information providing device to function as each of means of the information providing device,
the information providing device comprising:
service setting data storage means that stores, in a first storage section, service setting data in which service identification information of at least one service provided to an information display device corresponds to display attribute information indicating whether or not to display an object showing a brief description of the service identified by the service identification information, the service setting data being transmitted from the information display device;
display information reception means that receives, from the information display device, display information indicating, for each of the at least one service, whether or not to display the object on the information display device;
service setting data update means that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section;
display data generation means that, in response to a request from the information display device, generates:
display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and
display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and
display data transmission means that transmits, to the information display device, the display data generated.

12. A program causing a computer in an information display device to function as each of means of the information display device,
the information display device comprising:
service-setting-data-storage request means that requests the information providing device to store, in the information providing device, the service setting data stored in the second storage section of the information display device;
display information transmission means that transmits to the information providing device the display information, so that the service setting data stored in the information providing device is updated;
display data request means that makes a request for the display data generated based on the service setting data updated, to the information providing device; and
display data reception means that displays the object included in the display data acquired on a display section of the information display device, according to the control script that is included in the display data acquired from the information providing device in response to the request.

13. A computer-readable storage medium in which a program causing a computer in an information providing device to function as each of means of the information providing device is stored,
the information providing device comprising:
service setting data storage means that stores, in a first storage section, service setting data in which service identification information of at least one service provided to an information display device corresponds to display attribute information indicating whether or not to display an object showing a brief description of the service identified by the service identification information, the service setting data being transmitted from the information display device;
display information reception means that receives, from the information display device, display information indicating, for each of the at least one service, whether or not to display the object on the information display device;
service setting data update means that updates, at the time when the display information is received, the display attribute information so that (i) the object indicated, in the display information, to be displayed is displayed on the information display device and (ii) the object indicated, in the display information, not to be displayed is not displayed on the information display device, the display attribute information being included in the service setting data stored in the first storage section;
display data generation means that, in response to a request from the information display device, generates:
display data including (i) the object of the service identified by the service identification information and (ii) a control script for displaying the object on the information display device in a case where the service setting data stored in the first storage section has been updated, the identification information being associated with the display attribute information that is included in the service setting data updated and indicates to display the object on the information display device; and
display data including (i) the object of the service identified by the service identification information and (ii) the control script of the object in a case where the service setting data stored in the first storage section has not been updated, the identification information being associated with the display attribute information that is included in the service setting data included in the request and indicates to display the object on the information display device; and
display data transmission means that transmits, to the information display device, the display data generated.

14. A computer-readable storage medium in which a program causing a computer in an information display device to function as each of means of the information display device is stored,
the information display device comprising:
service-setting-data-storage request means that requests the information providing device to store, in the information providing device, the service setting data stored in the second storage section of the information display device;
display information transmission means that transmits to the information providing device the display information, so that the service setting data stored in the information providing device is updated;
display data request means that makes a request for the display data generated based on the service setting data updated, to the information providing device; and
display data reception means that displays the object included in the display data acquired on a display section of the information display device, according to the control script that is included in the display data acquired from the information providing device in response to the request.
